(19) United States
(12) Patent Application Publication
(10) Pub. No.: US 2023/0403244 A1
(43) Pub. Date: Dec. 14, 2023

(54) METHODS, MEDIUMS, AND SYSTEMS FOR RESPONDING TO A USER SERVICE PROMPT

(71) Applicant: Meta Platforms, Inc., Menlo Park, CA (US)

(72) Inventors: Willy Blandin, Bourg-la-Reine (FR); Laurent Nicolas Landowski, Garches (FR); Kemal El Moujahid, Belmont, CA (US); Henri Romeo Liriani, Oakland, CA (US); Heath William Black, Alameda, CA (US)

(73) Assignee: Meta Platforms, Inc., Menlo Park, CA (US)

(21) Appl. No.: 17/348,072

(22) Filed: Jun. 15, 2021

(51) Int. Cl. H04L 12/58; G06F 40/58

(52) U.S. Cl. CPC H04L 51/02; H04L 51/32; H04L 51/20; H04L 51/046; G06F 40/58

(57) ABSTRACT

Exemplary embodiments relate to methods, mediums, and systems for providing group bots that participate in a conversation between multiple participants. Unlike conventional bots that typically interact with users on a one-on-one basis, the group bots may interact collectively with a group, allowing the bots to (among other things) arbitrate decisions for the group, suggest events that all of the members of the group would find agreeable, facilitate conversations by recognizing core language differences between group members and providing translations in response, etc. Furthermore, the group bot may be invoked directly from a group conversation using natural language, and may provide a response directly in the conversation. Because these capabilities are provided directly within a conversation thread, conversation participants can more readily use the bot capabilities without the need to access separate functionality.

### CROSS-REFERENCE TO RELATED APPLICATIONS

This application is related to U.S. patent application Ser. No. 16/892,597, filed on Jun. 4, 2020 and entitled “Proactive and Reactive Suggestions for a Messaging System.”

### BACKGROUND

Users may interact with each other in a messaging system, sending messages back and forth in a text-based conversation. A user may have a user account associated with them in the messaging system, where the user account provides an online identity for the user (potentially including user preferences or other information about the user) and a destination for messages directed to the user, and generally coordinates the user's access to and use of the messaging system. A user may access the messaging system from a variety of endpoints, including mobile devices (e.g., cellphones), desktop computers, web browsers, specialized messaging clients, etc.

It is contemplated that the embodiments described below may be used separately or in combination. The attached Figures show the embodiments described below as a unified process, although individual parts of that process can be separated in order to achieve advantages as described herein. Furthermore, the summaries below may be described from a certain perspective (e.g., the primary device, the secondary device, the server, another participant in the conversation). It is understood that the invention is not limited to the specific actions as performed by the particular devices identified below. One of ordinary skill in the art will understand that complimentary actions are performed on the other devices, as described more fully in the Detailed Description that follows, in response to the specific actions summarized below. The phrases “in one embodiment,” “in another embodiment,” etc. are not intended to exclude those embodiments from being used together. For example, if a first embodiment is introduced by “in one embodiment,” and a second embodiment is introduced by “in another embodiment,” it is contemplated that the first and second embodiments could be used together or separately.

The techniques described herein may be embodied as computer-implemented methods, instructions stored on non-transitory computer readable media, computing apparatuses or systems, or any other suitable technology.

In one embodiment, a device may receive, in a messaging conversation, a user service prompt. The user service prompt may include natural language relating to a group interaction involving a plurality of participants in the conversation. The device may invoke a bot configured to respond to the user service prompt, identify sharable user information for each of the plurality of participants that is pertinent to the group interaction, and provide the sharable user information to the bot. The device may receive, from the bot, a response to the user service prompt determined at least partially based on the sharable user information. The response of the bot may be provided in the messaging conversation.

In another embodiment, the sharable user information may include a user preference for each of the respective plurality of participants in the conversation, and the bot is configured to identify a calendar event that the bot predicts the plurality of participants will be interested in attending.

In another embodiment, the sharable information may include at least one of identities or preferences of the plurality of participants in the conversation, and the bot may be configured to provide a selection of a subset of the identities or preferences. This allows the bot to serve as a “picker” that can randomly choose group members for certain tasks or group preferences, or that can arbitrate between different users or preferences to achieve an outcome that is preferable to the group as a whole.

In another embodiment, the sharable user information may include a reminder pertaining to the plurality of participants in the conversation. This allows the bot to send a message to all the members of the group at an appointed time, without the need to create individual reminders for each group member.

In another embodiment, the sharable user information may include respective core languages spoken by the plurality of participants in the conversation, and the bot may be configured to provide a translation of a message in the conversation based on a difference in the respective core languages.

In another embodiment, the sharable user information may include respective locations of the plurality of participants in the conversation (now or at some point in the future, as may be derived from the shareable user information), and the bot may be configured to provide an indication of weather at the respective locations.

In another embodiment, the plurality of participants in the conversation may each be users of a social network, and the sharable information may be retrieved from the social network. Accordingly, the bot (which may be deployed in a messaging system) can make use of the information that the user has chosen to share in the social network, which may increase the amount of information available to the bot so that the bot can make even better group decisions.

Other technical features will be readily apparent to one skilled in the art from the following figures, descriptions, and claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts an example of a consumer-to-business messaging system in accordance with one embodiment.

FIG. 2 depicts an example of a social graph in accordance with one embodiment.

FIG. 3 depicts an embodiment of a consumer-to-business messaging system determining a user intent based on a messaging interaction in accordance with one embodiment.

FIG. 4 depicts a consumer-to-business messaging system determining a messaging bot options configuration based on a user intent in accordance with one embodiment.

FIG. 5 depicts a consumer-to-business messaging system determining a messaging bot options configuration based on a user information exchange and a bot information exchange in accordance with one embodiment.

FIG. 6 depicts an exemplary interface for a messaging application in which a participant in a group conversation expressly invokes a suggestions interface in accordance with one embodiment.

FIG. 7 depicts an exemplary interface for a messaging application in which the messaging service proactively offers a suggestion without an express invocation in accordance with one embodiment.

FIG. 8 depicts an example of a polling mini-app presented in a messaging interface in accordance with one embodiment.

FIG. 9 depicts an example of a poll added to a conversation based on the polling mini-app.in accordance with one embodiment.

FIG. 10 depicts an example of an event recommendation group bot in accordance with one embodiment.

FIG. 11 depicts an example of a picker group bot in accordance with one embodiment.

FIG. 12 depicts an example of a reminder group bot in accordance with one embodiment.

FIG. 13A depicts an example of a translation group bot in accordance with one embodiment.

FIG. 13B depicts an example of a translation group bot in accordance with one embodiment.

FIG. 13C depicts an example of a translation group bot in accordance with one embodiment.

FIG. 14 depicts an example of a weather group bot in accordance with one embodiment.

FIG. 15 is a flow chart depicting exemplary logic for providing a group bot in accordance with one embodiment.

FIG. 16 illustrates an exemplary messaging service 1600 in accordance with one embodiment.

FIG. 17 depicts an illustrative computer system architecture that may be used to practice exemplary embodiments described herein.

### DETAILED DESCRIPTION

Exemplary embodiments relate to methods, mediums, and systems for providing group bots that participate in a conversation between multiple participants. Unlike conventional bots that typically interact with users on a one-on-one basis, the group bots may interact collectively with a group, allowing the bots to (among other things) arbitrate decisions for the group, suggest events that all of the members of the group would find agreeable, facilitate conversations by recognizing core language differences between group members and providing translations in response, etc. Furthermore, the group bot may be invoked directly from a group conversation using natural language, and may provide a response directly in the conversation. Because these capabilities are provided directly within a conversation thread, conversation participants can more readily use the bot capabilities without the need to access separate functionality.

For example, in a conventional messaging system, users might be discussing when to set up a meeting. In a conventional system, one or more of the group users might need to open a separate calendar application in order to examine each group member's schedule and determine what times might be acceptable to the entire group.

When group capabilities like the ones described herein are not provided in-thread in a messaging conversation, the users are less likely to use these capabilities (instead, they are more likely to sort out any scheduling or preferences between themselves, in the conversation). Users are also less likely to investigate functionality that they find cumbersome, and so they might not even be aware that group capabilities (e.g., group scheduling capabilities) exist, if they are not able to access them from within the thread.

Even if a user is aware that such a functionality exists and is willing to use it, if the functionality is not provided in the thread itself it may require that the user navigate within a series of menus within the messaging application (or even worse, navigate to an entirely different application). In addition to being less efficient, this navigation takes the user's focus away from an ongoing conversation. It would be preferable if the user could continue to monitor and participate in the conversation while accessing the group capabilities; in addition to allowing the user to continue to converse with the group, further development of the conversation may change the way that the user wishes to apply the group capability. For instance, a group of users might be debating which movie to see. If one user leaves the conversation to attempt to find movie times that are acceptable to the entire group, they might miss a message indicating that one of the group members isn't able to make the movie and that their schedule should not be taken into account. This information might be relevant to a group scheduling capability, but the user that left the conversation to handle the scheduling would not be privy to the information.

Moreover, when a user needs to access an entirely different application to use a certain functionality (e.g., using a calendar application to determine a group schedule), the increased number of running applications increases drain on processing, memory, and battery resources of the device.

Furthermore, because the bot's capabilities are shared between a group of people, the bot is better able to coordinate between multiple different schedules, preferences, or other user parameters. To that end, the bot might identify shareable information that the group participants have authorized the bot to access (e.g., publicly available information, or other information that the users have expressly authorized the bot to use for limited purposes). For example, the conversation participants might authorize the bot to see their schedules so that the bot can suggest times when the conversation participants are collectively free. In another embodiment, the users might authorize the bot to see their primary languages, so that the bot can determine if there is a mismatch between conversation participants and automatically provide translations of the conversation. This allows these capabilities to be provided more seamlessly than when a bot is tied to a particular user. In the translation example, a conventional bot activated by a first user might be able to provide translations of a second user's messages into the first user's language upon request. However, this might not help a third user understand the other users' messages, and furthermore many different translations might have to be done if many different languages are spoken in the conversation. In contrast, when the bot's capabilities are shared between all the members of the group, the bot can identify all the different languages spoken by the group members. This allows the bot to refrain from translating messages that the bot knows users can understand, translate other messages into a language commonly spoken among group members, and/or provide different translations for different group members.

Various group bot capabilities are described herein, although the present invention is not limited to the particular applications discussed. Among other possibilities, group bots may be particularly well-suited to suggesting events for the group to participate in, choosing between group members or group preferences, setting group reminders, performing translations or transcriptions, and providing group weather forecasts. In some embodiments, the shareable information used by the bot to provide these and other group capabilities may originate in a social network associated with the messaging service.

As used herein, a conversation or conversation thread generally refers to a collection of messages all addressed to the same group of users. A conversation or thread may be associated with a thread identifier which is used to display the thread as a distinct entity (separate from other threads) in a user interface of a messaging system. If a user is added to, or removed from, a conversation thread, then generally a new thread is created and a new thread ID is assigned.

Various embodiments note that a response of a bot may be provided in a messaging conversation. This generally refers to having the bot provide the response in the same interface in which the messages of the conversation thread are being displayed. This may entail displaying the response as part of a message in a conversation thread. In addition or alternatively, the bot may place an interactable widget or application into the thread (inside or outside of a message in the thread). The bot may be an implicit participant in the conversation or thread, such that the bot becomes a conversation participant (potentially temporarily) but the thread identifier is not changed.

Similarly, when a bot is invoked from within a thread, this generally refers to activating the capabilities of the bot from the same interface in which the messages of the conversation thread are being displayed. The bot might be invoked explicitly or implicitly in a message sent by a user into the thread, or by selecting the bot from a panel in the conversation thread display interface.

Some embodiments also note that the bot capabilities are shared by members of the group. Generally, the bot is able to access user parameters (e.g., shareable data) for multiple people (e.g., all the group participants) in order to formulate its response. The response may be generated collectively for the group based on the data gathered from the group. The response may be provided to all of the members of the group. Any of the conversation participants may be capable of invoking the bot in the conversation.

### A Note on Data Privacy

Some embodiments described herein make use of training data or metrics that may include information voluntarily provided by one or more users. In such embodiments, data privacy may be protected in a number of ways.

For example, the user may be required to opt in to any data collection before user data is collected or used. The user may also be provided with the opportunity to opt out of any data collection. Before opting in to data collection, the user may be provided with a description of the ways in which the data will be used, how long the data will be retained, and the safeguards that are in place to protect the data from disclosure.

Any information identifying the user from which the data was collected may be purged or disassociated from the data. In the event that any identifying information needs to be retained (e.g., to meet regulatory requirements), the user may be informed of the collection of the identifying information, the uses that will be made of the identifying information, and the amount of time that the identifying information will be retained. Information specifically identifying the user may be removed and may be replaced with, for example, a generic identification number or other non-specific form of identification.

Once collected, the data may be stored in a secure data storage location that includes safeguards to prevent unauthorized access to the data. The data may be stored in an encrypted format. Identifying information and/or non-identifying information may be purged from the data storage after a predetermined period of time.

Although particular privacy protection techniques are described herein for purposes of illustration, one of ordinary skill in the art will recognize that privacy protected in other manners as well. Further details regarding data privacy are discussed below in the section describing network embodiments.

Assuming a user's privacy conditions are met, exemplary embodiments may be deployed in a wide variety of messaging systems, including messaging in a social network or on a mobile device (e.g., through a messaging client application or via short message service), among other possibilities. An overview of exemplary logic and processes for performing exemplary embodiments is next provided.

### Exemplary Embodiments

As an aid to understanding, a series of examples will first be presented before detailed descriptions of the underlying implementations are described. It is noted that these examples are intended to be illustrative only and that the present invention is not limited to the embodiments shown.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 122 illustrated as components 122-1 through 122-a may include components 122-1, 122-2, 122-3, 122-4, and 122-5. The embodiments are not limited in this context.

### Messaging Bots

Network-connected computing devices can provide their users with an unprecedented ability to engage in interpersonal communication. For instance, people may engage in messaging interactions with their friends, family, coworkers, and other associates. A user's message exchanges with a particular set of contacts may be maintained within distinct message threads.

These network-connected computing devices can also provide their users with access to network-accessible services. For instance, transportation services, dining services, entertainment services, and other services may use web sites, web applications, client applications, or other network-accessibility techniques to empower people to use their client devices to engage with their services. In some cases, such as some entertainment or media services, the service can be both arranged and delivered via the client devices. For example, music may be purchased via a client device and delivered to the client device for playback. In other cases, such as with transportation, dining, and in-person entertainment, the service can be arranged via the client devices, but is performed external to the client device. For example, a ride-sharing service may be arranged via a client device but performed through a vehicle and driver providing ride sharing to the user.

In some cases, the use of a network-accessible service may relate to more than one person. Particularly where a user's access to the service is a client device that they also use for messaging, a user may benefit from sharing their engagement with the network-accessible service in the messaging client with the others to whom the service relates. As such, message threads may act as hubs for a user's online social relationship with their contacts, with the message threads incorporating services requested, monitored, or engaged with via the same client used for messaging.

To aid a user in interacting with a service via a messaging context, services may be represented as messaging bots within a messaging system. A messaging bot may be an automated front-end to a network-accessible service that can be represented as a participant within a message thread. In some cases, a messaging bot may be corresponded with in a message thread that explicitly includes the messaging bot, such as a one-on-one message thread between a particular user and the messaging bot. In other cases, a messaging bot may be corresponded with in a message thread in which the messaging bot is not a regular participant, the messaging bot a temporary participant in the message thread for the purposes of interacting with the service. The messaging bot may be included as a temporary participant in any other thread, whether a one-on-one thread between two users or a group thread between multiple users.

As such, a user may engage with network services within the familiar experience of a messaging client. Further, by using a messaging client, a user may engage with network services within a messaging context so as to allow the inclusion of other people. In some cases, this may simply inform the other people as to the services, such as letting friends or family know about transportation details. In other cases, this may empower the performance of services for multiple people, such as where dinner, a ride, entertainment, or other service is arranged for the use of multiple people. As a result, the embodiments can improve the experience of using network-accessible services and can extend the reach of network-accessible services to the user of a messaging system.

A developer may be aided by being provided a natural way to specify the capabilities of their messaging bot. The bot platform may provide a bot engine that empower developers to define the capabilities of their bots using a set of developer-defined examples. Examples may be example statements or conversations that the developer believes should cause their messaging bot to be recommended. As a result, the embodiments can reduce the difficult of determining messaging bots for recommendation to a user.

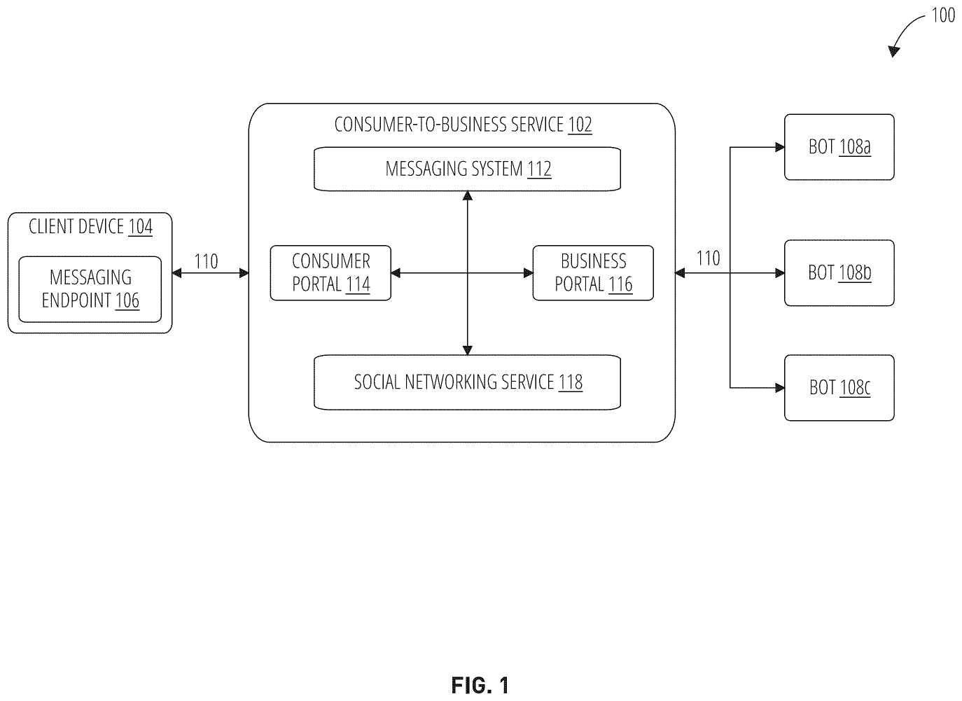

FIG. 1 illustrates a block diagram for a consumer-to-business communication system 100. In one embodiment, the consumer-to-business communication system 100 may comprise a computer-implemented system having software applications comprising one or more components. Although the consumer-to-business communication system 100 shown in FIG. 1 has a limited number of elements in a certain topology, it may be appreciated that the consumer-to-business communication system 100 may include more or less elements in alternate topologies as desired for a given implementation.

A consumer-to-business service 102 may serve as an intermediary between consumers and businesses. Consumers and businesses may both be users of the consumer-to-business service 102, with consumers represented via an individual user account and businesses represented by a commerce account and, possibly, one or more individual user accounts associated with the business, such as individual user accounts associated with representatives and other employees of the business. A consumer user may be represented with a user entity in a social graph. A business or other commercial user may be represented by a business entity in a social graph. The relationship between the consumer user and the commercial user may be represented by one or more edges between the user entity and business entity in the social graph.

The consumer-to-business service 102 may comprise a messaging system 112. The messaging system 112 may be generally arranged to receive, store, and deliver messages between individual entities such as individual users and collective entities such as businesses and other organizations. The messaging system 112 may store messages while messaging endpoints, such as messaging endpoint 106, are offline and deliver the messages once the messaging endpoints are available. The messaging system 112 may empower a user to use multiple messaging endpoints 106 (e.g., a messaging client on a mobile device, a web browser on a personal computer) for the same user account, with the messaging system 112 keeping all of the messaging endpoints 106 up-to-date as to the messaging state of the user account.

The consumer-to-business service 102 may comprise a social networking service 118. The social networking service 118 may maintain a social graph data structure representing a social graph. The social graph may represent relationships between entities, such as user entities, commerce entities, and any other sort of entity. The social graph may represent the relationships as graph relationships, in which all information is encoded as either being attached to a particular node in the graph or attached to a particular edge between two nodes in the graph. A messaging system 112 may be an element of a social networking service 118, with the social graph containing, at least in part, social-networking information. The whole of the consumer-to-business service 102 may be an element or composed of elements of a social networking service.

The consumer-to-business service 102 may comprise a consumer portal 114. The consumer portal 114 may be a unified entry point into the consumer-to-business service 102 for client applications being used by consumers. The consumer portal 114 may serve as a general user portal for non-commerce entities, including users that are not or do not engage in commerce using the consumer-to-business service 102. The consumer portal 114 may provide access to the messaging system 112 and the social networking service 118. In some embodiments, all access to the social networking service 118 may be mediated by the consumer portal 114 in which the information of the social networking service 118 is used and managed on behalf of the user without the user having direct access to some or all of the social graph information. In some embodiments, the user may have direct access to the messaging system 112 using their user account, with the consumer portal limited to consumer functions of the consumer-to-business service 102 with general messaging functionality (e.g., messaging with friends) provided through direct network communication between the messaging endpoint 106 and the messaging system 112 without the mediation of the consumer portal 114.

The consumer-to-business service 102 may comprise a business portal 116. The business portal 116 may be a unified entry point into the consumer-to-business service 102 for client application being used by business entities. The business portal 116 may provide access to the messaging system 112 and the social networking service 118. In some embodiments, all access to the social networking service 118 may be mediated by a business portal 116 in which the information of the social networking service 118 is used and managed on behalf of the business entity without the business entity having direct access to some or all of the social graph information. In some embodiments, the business entity may have direct access to the messaging system 112 using their commerce account, with the business portal 116 limited to business functions of the consumer-to-business service 102 with general messaging functionality (e.g., messaging with customers) provided through direct network communication between one or more bots 108a, b, c . . . and the messaging system 112 without the mediation of the business portal 116.

A user may participate in the consumer-to-business communication system 100 and interact with the consumer-to-business service 102 using a messaging endpoint 106 software application executing on a client device 104. The client device 104 may be a smartphone—a mobile phone capable of executing software applications that provide functionality beyond that of a conventional telephone. The messaging endpoint 106 may be specifically associated with a particular messaging system 112 that forms part of the consumer-to-business service 102 or may be a general-purpose messaging client operative to interact with a plurality of messaging services. The messaging endpoint 106 may interact with one or both of the consumer portal 114 and the messaging system 112 for the performance of messaging tasks and commerce tasks.

A business entity may be represented in a messaging system by a commerce representation comprising a collection of information for display to a user. A commerce representation may comprise a business page, the business page being the identity of a business within the consumer-to-business communication system 100. The business page may display information regarding a business entity. The business page may include information for the business entity, such as one or more of a physical location for the business entity, the operating hours of the physical location, or the hours in which the business entity (e.g., a representative of the business entity) is available for messaging through the consumer-to-business communication system 100. The business page may include social-networking information for the business entity, such as a list of friends of a viewing user that have “liked” or “followed” the business entity within a social network as may be represented in a social graph.

A commerce representation may not correspond precisely to a business entity. A single business entity, such as a business, may have multiple commerce representations and therefore multiple business pages. For example, a single business may have different representations for different brands owned and operated by the same business. A retailer or reseller may sell multiple brands and may have different representations for different brands that they sell. A business may have different representations for different geographic areas in which they operate, such as one business page for the United States, another for Europe, another for Russia, etc.

To aid a user in interacting with a service within a messaging context, services may be represented as bots 108a, b, c, . . . A bot may be a fully or partially automated front-end to a network-accessible service that can be represented as a participant in an interaction. In some instances, an interaction may comprise a messaging interaction embodied within a message thread, with the bots 108a, b, c. . . comprising messaging bots. In some cases, a messaging bot may be corresponded with in a message thread that explicitly includes the messaging bot, such as a one-on-one message thread between a particular user and the messaging bot. In other cases, a messaging bot may be corresponded with in a message thread in which the messaging bot is not a regular participant, the messaging bot a temporary participant in the message thread for the purposes of interacting with the service. The messaging bot may be included as a temporary participant in any other thread, whether a one-on-one thread between two users or a group thread between more than two users.

Bots 108a, b, c, . . . may interact with users using communication channels other than messaging. For example, a bot may comprise a voice bot operating via a voice system, such as a smartphone, personal computer, voice-activated appliance, or other device with which a user may interact via voice. In these embodiments, the voice system may perform voice recognition and voice generation on behalf of the bots 108a, b, c, . . . Other types of interactive systems may be used to mediate between bots 108a, b, c, . . . and users.

A messaging bot for a commerce representation may be presented in a messaging conversation in a messaging system 112. A user of the messaging system 112 may interact with a business by messaging with the messaging bot that comprises a virtual representation of the business. A messaging bot may specifically correspond to a commerce representation presented as a business page, with the messaging bot being the representation of the business page in a messaging context. Messaging with the bot may therefore extend the presence of a commerce representation from a business page, primarily dedicated to providing information from the business to users, to interactive messaging in which users and the business can engage in a conversation.

A business may use one or more commerce applications to engage with the messaging system 112. An application may correspond to a specific registration empowering access to the messaging system 112 and/or social networking service 118 via an application programming interface (API). An application may be registered with the messaging system 112 via various registered hooks for the application specifying how the application can be contacted by the messaging system 112. These hooks may be used to contact the application in response to events, such as user messaging, within the messaging system 112. An application may be assigned a secure token that may be used for authentication and the secure (e.g., encrypted) reception and sending of information with the messaging system 112. An application may correspond to a specific AppID with the messaging system 112 and/or social networking service 118. Because the business may surface multiple aspects of the services and products it provides via the agent, multiple different applications may be used by a business entity to interact with a user via the messaging system 112. Each application may be subscribed with the messaging system 112 to the one or more commerce representations, such as business pages, that it powers.

The network 110 may comprise any form of computer network operative to carry computer transmissions between computer devices. The network 110 may include one or both of intranets and the Internet. The network 180 may include cellular data and/or Wi-Fi data networks, such as may be used to provide connectivity to a mobile client device 120.

The consumer-to-business communication system 100 may use knowledge generated from interactions between users. The consumer-to-business communication system 100 may comprise a component of a social networking service 118 and may use knowledge generated from the broader interactions of the social networking service 118. As such, to protect the privacy of the users of the consumer-to-business communication system 100 and the larger social networking service 118, consumer-to-business communication system 100 may include an authorization server (or other suitable component(s)) that allows users to opt in to or opt out of having their actions logged by the consumer-to-business communication system 100 or shared with other systems (e.g., third-party systems), for example, by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers or other authorization components may be used to enforce one or more privacy settings of the users of the consumer-to-business communication system 100 and other elements of a social networking service 118 through blocking, data hashing, anonymization, or other suitable techniques as appropriate. For example, while interactions between users of a social networking service 130 and the social networking service 118 may be used to learn media content preferences and the relationship between preferences for different pieces of content, these interactions may be anonymized prior to or as part of the learning process.

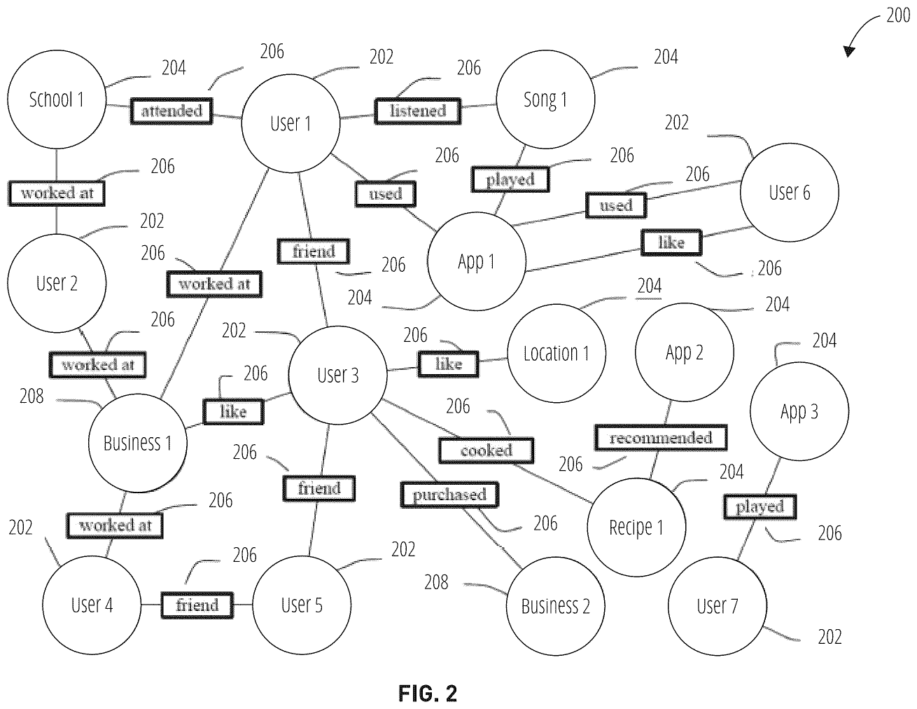

FIG. 2 illustrates an example of a social graph 200. In particular embodiments, a social-networking system may store one or more social graphs 200 in one or more data stores as a social graph data structure.

In particular embodiments, social graph 200 may include multiple nodes, which may include multiple user nodes 202 and multiple concept node 204. Social graph 200 may include multiple edges 206 connecting the nodes. In particular embodiments, a social-networking system, client system, third-party system, or any other system or device may access social graph 200 and related social-graph information for suitable applications. The nodes and edges of social graph 200 may be stored as data objects, for example, in a data store (such as a social-graph database). Such a data store may include one or more searchable or queryable indexes of nodes or edges of social graph 200.

In particular embodiments, a user node 202 may correspond to a user of the social-networking system. As an example and not by way of limitation, a user may be an individual (human user), an entity (e.g., an enterprise, business, or third-party application), or a group (e.g., of individuals or entities) that interacts or communicates with or over the social-networking system. In particular embodiments, when a user registers for an account with the social-networking system, the social-networking system may create a user node 202 corresponding to the user, and store the user node 202 in one or more data stores. Users and user nodes 202 described herein may, where appropriate, refer to registered users and user nodes 202 associated with registered users. In addition or as an alternative, users and user nodes 202 described herein may, where appropriate, refer to users that have not registered with the social-networking system. In particular embodiments, a user node 202 may be associated with information provided by a user or information gathered by various systems, including the social-networking system. As an example and not by way of limitation, a user may provide their name, profile picture, contact information, birth date, sex, marital status, family status, employment, education background, preferences, interests, or other demographic information. In particular embodiments, a user node 202 may be associated with one or more data objects corresponding to information associated with a user. In particular embodiments, a user node 202 may correspond to one or more webpages. A user node 202 may be associated with a unique user identifier for the user in the social-networking system.

In particular embodiments, a concept node 204 may correspond to a concept. As an example and not by way of limitation, a concept may correspond to a place (such as, for example, a movie theater, restaurant, landmark, or city); a website (such as, for example, a website associated with the social-network service or a third-party website associated with a web-application server); an entity (such as, for example, a person, business, group, sports team, or celebrity); a resource (such as, for example, an audio file, video file, digital photo, text file, structured document, or application) which may be located within the social-networking system or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 204 may be associated with information of a concept provided by a user or information gathered by various systems, including the social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 204 may be associated with one or more data objects corresponding to information associated with concept node 204. In particular embodiments, a concept node 204 may correspond to one or more webpages.

In particular embodiments, a node in social graph 200 may represent or be represented by a webpage (which may be referred to as a “profile page”). Profile pages may be hosted by or accessible to the social-networking system. Profile pages may also be hosted on third-party websites associated with a third-party server. As an example and not by way of limitation, a profile page corresponding to a particular external webpage may be the particular external webpage and the profile page may correspond to a particular concept node 204. Profile pages may be viewable by all or a selected subset of other users. As an example and not by way of limitation, a user node 202 may have a corresponding user-profile page in which the corresponding user may add content, make declarations, or otherwise express himself or herself. A business page corresponding to a business node 208 may comprise a user-profile page for a commerce entity. As another example and not by way of limitation, a concept node 204 may have a corresponding concept-profile page in which one or more users may add content, make declarations, or express themselves, particularly in relation to the concept corresponding to concept node 204.

In particular embodiments, a concept node 204 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system to send to the social-networking system a message indicating the user's action. In response to the message, the social-networking system may create an edge (e.g., an “eat” edge) between a user node 202 corresponding to the user and a concept node 204 corresponding to the third-party webpage or resource and store edge 206 in one or more data stores.

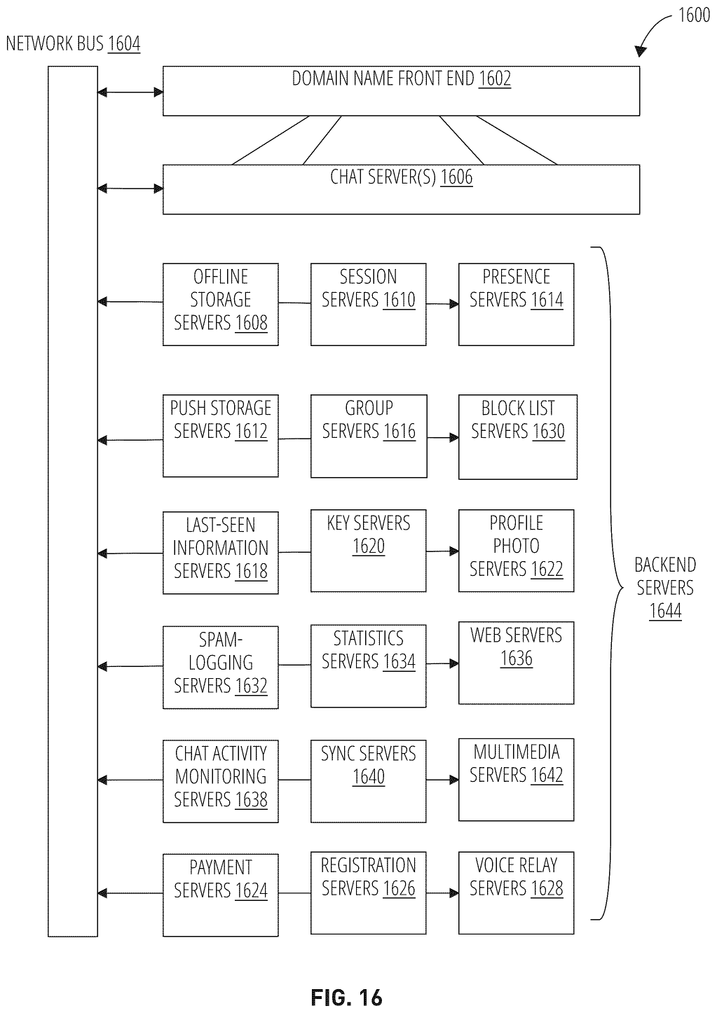

In particular embodiments, a pair of nodes in social graph 200 may be connected to each other by one or more edges 206. An edge 206 connecting a pair of nodes may represent a relationship between the pair of nodes. In particular embodiments, an edge 206 may include or represent one or more data objects or attributes corresponding to the relationship between a pair of nodes. As an example and not by way of limitation, a first user may indicate that a second user is a “friend” of the first user. In response to this indication, the social-networking system may send a “friend request” to the second user. If the second user confirms the “friend request,” the social-networking system may create an edge 206 connecting the first user's user node 202 to the second user's user node 202 in social graph 200 and store edge 206 as social-graph information in one or more data stores. In the example of FIG. 16, social graph 200 includes an edge 206 indicating a friend relation between user nodes 202 of user “Amanda” and user “Dorothy.” Although this disclosure describes or illustrates particular edges 206 with particular attributes connecting particular user nodes 202, this disclosure contemplates any suitable edges 206 with any suitable attributes connecting user node 202. As an example and not by way of limitation, an edge 206 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 200 by one or more edges 206.

In particular embodiments, an edge 206 between a user node 202 and a concept node 204 may represent a particular action or activity performed by a user associated with user node 202 toward a concept associated with a concept node 204. As an example and not by way of limitation, as illustrated in FIG. 2, a user may “like,” “attended,” “played,” “listened,” “cooked,” “worked at,” or “watched” a concept, each of which may correspond to a edge type or subtype. A concept-profile page corresponding to a concept node 204 may include, for example, a selectable “check in” icon (such as, for example, a clickable “check in” icon) or a selectable “add to favorites” icon. Similarly, after a user clicks these icons, the social-networking system may create a “favorite” edge or a “check in” edge in response to a user's action corresponding to a respective action. As another example and not by way of limitation, a user may listen to a particular song using a particular application . In this case, the social-networking system may create a “listened” edge 206 and a “used” edge (as illustrated in FIG. 2) between user node 202 corresponding to the user and concept nodes 204 corresponding to the song and application to indicate that the user listened to the song and used the application. Moreover, the social-networking system may create a “played” edge 206 between concept node 204 corresponding to the song and the application to indicate that the particular song was played by the particular application. In this case, “played” edge 206 corresponds to an action performed by an external application on an external audio file. Although this disclosure describes particular edges 206 with particular attributes connecting user nodes 202 and concept nodes 204, this disclosure contemplates any suitable edges 206 with any suitable attributes connecting user nodes 202 and concept nodes 204. Moreover, although this disclosure describes edges between a user node 202 and a concept node 204 representing a single relationship, this disclosure contemplates edges between a user node 202 and a concept node 204 representing one or more relationships. As an example and not by way of limitation, an edge 206 may represent both that a user likes and has used at a particular concept. Alternatively, another edge 206 may represent each type of relationship (or multiples of a single relationship) between a user node 202 and a concept node 204 (as illustrated in FIG. 2 between user node 202 for user User 6 and concept node 204 for App 1).

In particular embodiments, the social-networking system may create an edge 206 between a user node 202 and a concept node 204 in social graph 200. As an example and not by way of limitation, a user viewing a concept-profile page (such as, for example, by using a web browser or a special-purpose application hosted by the user's client system) may indicate that he or she likes the concept represented by the concept node 204 by clicking or selecting a “Like” icon, which may cause the user's client system to send to the social-networking system a message indicating the user's liking of the concept associated with the concept-profile page. In response to the message, the social-networking system may create an edge 206 between user node 202 associated with the user and concept node 204, as illustrated by “like” edge 206 between the user and concept node 204. In particular embodiments, the social-networking system may store an edge 206 in one or more data stores. In particular embodiments, an edge 206 may be automatically formed by the social-networking system in response to a particular user action. As an example and not by way of limitation, if a first user uploads a picture, watches a movie, or listens to a song, an edge 206 may be formed between user node 202 corresponding to the first user and concept nodes 204 corresponding to those concepts. Although this disclosure describes forming particular edges 206 in particular manners, this disclosure contemplates forming any suitable edges 206 in any suitable manner.

The social graph 200 may further comprise a plurality of product nodes. Product nodes may represent particular products that may be associated with a particular business. A business may provide a product catalog to the consumer-to-business service 102 and the consumer-to-business service 110 may therefore represent each of the products within the product in the social graph 200 with each product being in a distinct product node. A product node may comprise information relating to the product, such as pricing information, descriptive information, manufacturer information, availability information, and other relevant information. For example, each of the items on a menu for a restaurant may be represented within the social graph 200 with a product node describing each of the items. A product node may be linked by an edge to the business providing the product. Where multiple businesses provide a product, each business may have a distinct product node associated with its providing of the product or may each link to the same product node. A product node may be linked by an edge to each user that has purchased, rated, owns, recommended, or viewed the product, with the edge describing the nature of the relationship (e.g., purchased, rated, owns, recommended, viewed, or other relationship). Each of the product nodes may be associated with a graph id and an associated merchant id by virtue of the linked merchant business. Products available from a business may therefore be communicated to a user by retrieving the available product nodes linked to the user node for the business within the social graph 200. The information for a product node may be manipulated by the social-networking system as a product object that encapsulates information regarding the referenced product.

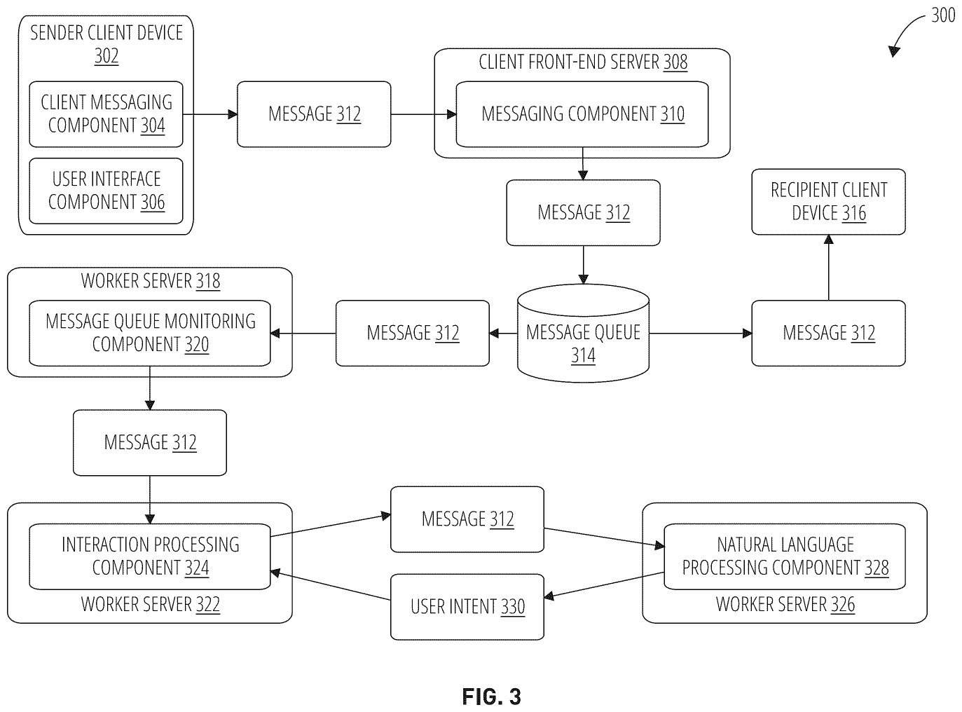

FIG. 3 illustrates an embodiment of a consumer-to-business communication system 300 determining a user intent 330 based on a messaging interaction.

A messaging system messaging system 112 may comprise a plurality of components. In some embodiments, these plurality of components may be distributed among a plurality of servers. In other embodiments, a single server may implement the plurality of components. In some embodiments, a plurality of servers may be executed by a single server device. In other embodiments, the plurality of servers may be executed by a plurality of server devices. In some embodiments, multiple instances of the various components and various servers may be executed to provide redundancy, improved scaling, and other benefits. Similarly, a client device may execute a plurality of components as part of a messaging client.

A client device may communicate with other devices using wireless transmissions to exchange network traffic. Exchanging network traffic, such as may be included in the exchange of messaging transactions, may comprise transmitting and receiving network traffic via a network interface controller (NIC). A NIC comprises a hardware component connecting a computer device, such as client device, to a computer network. The NIC may be associated with a software network interface empowering software applications to access and use the NIC. Network traffic may be received over the computer network as signals transmitted over data links. The network traffic may be received by capturing these signals and interpreting them. The NIC may receive network traffic over the computer network and transfer the network traffic to memory storage accessible to software applications using a network interface application programming interface (API). The network interface controller may be used for the network activities of the embodiments described herein, including the interoperation of the messaging client and messaging servers through network communication. For example, the messaging client transmitting or receiving messages to or from a client front-end server 308 may be interpreted as using the network interface controller for network access to a communications network for the transmission or reception of information.

A messaging client may comprise a user interface component 306. A user interface component 306 may be generally arranged to display user interfaces to a user of a client device and to receive user commands for the messaging client for the client device. A messaging client may comprise a messaging components 304. A messaging components 304 may be generally arranged to conduct messaging interactions on the behalf of the messaging client via communication with the client front-end server 308.

A client front-end server 308 may be generally arranged to act as a network access point to the messaging system for client devices such as a sender client device 302. The client front-end server 308 may comprise a messaging component 310, the messaging component 310 generally arranged to act as a network access point to messaging services for the messaging system 112. The messaging component 310 may receive messages 312 from client devices and add the messages 312 to message queues 314.

A message queue 314 may be specifically associated with the user of sender client device 302, such as by being uniquely associated within the messaging system 112 with a user account for the user of sender client device 302. The message queue 314 may be a single queue used for all messaging endpoints used by this user. The message queue 314 may comprise a representation of updates in a strict linear order. The message queue 314 may be organized as a data unit according to a variety of techniques. The message queue 314 may be stored in semi-persistent memory, persistent storage, both semi-persistent memory and persistent storage, or a combination of the two. The message queue 314 may be organized according to a variety of data structures, including linked lists, arrays, and other techniques for organizing queues. The message queue 314 may generally comprise a first-in-first-out (FIFO) queue in which no update will be removed or retrieved from the queue before any updates that were received prior to it.

The messaging system 112 may comprise one or more worker servers, such as worker server 318, worker server 322, and worker server 326. In general, the messaging system 112 may comprise a plurality of worker servers that may be assigned to various tasks. A worker server 318 may comprise a message queue monitoring component 320, the message queue monitoring component 320 arranged to monitor updates, such as may comprise messages, in the message queue 314 and other message queues of the messaging system 112 for various flags, indicators, and other information. A worker server 322 may comprise an interaction processing component 324, the interaction processing component 324 operative to manage the generation of a user intent 330 based on the contents of a messaging interaction. A worker server 326 may comprise a natural language processing component 328, the natural language processing component 328 operative to use natural-language processing techniques to analyze messaging interactions and generate user intent 330 based on the messaging interactions. The natural language processing component 328 may comprise a natural-language machine-learning component operative to use natural-language machine-learning techniques to improve its NLP operations.

The interaction processing component 324 may interface with the natural language processing component 328. The natural language processing component 328 performs natural-language processing for the consumer-to-business communication system 300. The performance of natural-language processing may include the analysis the contents of a messaging interaction to determine an intent of the messaging interaction. The intent represents a goal being sought to by the messaging interaction. For instance, people discussing where to get dinner may have an intent of “dining,” “eating,” “restaurant,” or other related term. The interaction processing component 324 may provide the content of a messaging interaction, including one or more messages, to the natural language processing component 328 and the natural language processing component 328 replies with the user intent 330, or multiple user intents, it detects for that interaction. The natural language processing component 328 may be implemented using known natural language processing (NLP) and machine learning (ML) techniques.

The message queue monitoring component 320 monitors a messaging interaction. This messaging interaction is exchanged via a messaging system 112. This messaging interaction involving at least one client device, such as a sender client device 302 and/or a recipient client device 316. A message 312 may be sent from a messaging components 304 of a messaging client on a sender client device 302. This message 312 is associated with a message thread, the message thread involving two or more participants, including the user of the sender client device 302. This message 312 comprises a portion of the messaging interaction of a message thread.

The message 312 is received by the messaging component 310 of the client front-end server 308 and is added to a message queue 314 associated with the sender. The message 312 is distributed using the message queue 314 to the recipient client device 316. The message queue monitoring component 320 also receives the message 312 and provides it to the interaction processing component 324.

The interaction processing component 324 provides the message 312 to the natural language processing component 328 and receives the user intent 330 in response. The message 312 may be provided to the natural language processing component 328 as part of a repository of multiple messages, so as to empower the analysis of a messaging interaction as a whole. As such, the interaction processing component 324 determines determine a user intent for the messaging interaction by submitting at least a portion of the messaging interaction to a natural language processing component 328 and receiving the user intent 330 from the natural language processing component 328 in response to submitting at least the portion of the messaging interaction to the natural language processing component 328. The interaction processing component 324 may therefore detect the user intent 330 for the messaging interaction by using the natural language processing component 328.

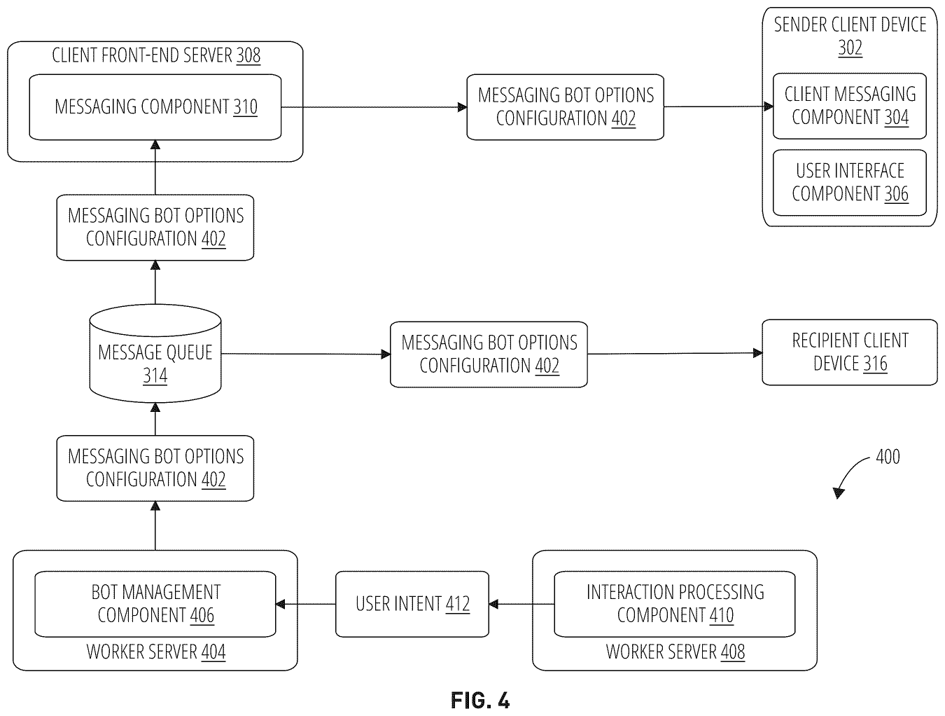

FIG. 4 illustrates an embodiment of a consumer-to-business communication system 400 determining a messaging bot options configuration 402 based on a user intent 412.

In some embodiments, a consumer-to-business communication system 300 may include a bot management component 406 that acts as an access point to messaging bot services for the consumer-to-business communication system 300. The bot management component 406 may act as an intermediary between the servers of the messaging system 112 and one or more internal and/or external bot execution servers. The bot management component 406 may comprise a bot framework generally arranged to provide an accessible framework to the messaging bot system. The bot management component 406 may be executed by a worker server 404 substantially similar to the worker servers described with reference to FIG. 3.

In some cases, messaging bots may be executed by servers external to the consumer-to-business communication system 300, such as an external bot server operated by the service associated with the bot. A bot management component 406 may determine an external bot server for the service associated with the messaging bot. The bot management component 406 may submit messages to the messaging bot by sending the messages to the external bot server associated with the messaging bot. In some embodiments, submitting messages may comprise extracting message content and transmitting the message content to the external bot server using a bot server interaction application programming interface (API). Bot messages from the messaging bots may similarly be received by the bot management component 406 from an external bot server.

In other cases, messaging bots may be executed by the servers of the consumer-to-business communication system 300. The bot management component 406 may determine a hosted bot server for the service associated with a messaging bot. A hosted bot server may comprise a bot server maintained by the provider of the consumer-to-business communication system 300. The bot management component 406 may submit messages to the messaging bot by sending the messages to the hosted bot server associated with the messaging bot and may receive messages from the messaging bot by receiving them from the hosted bot server.

The bot management component 406 receives the user intent 412 from the interaction processing component 410 and determines a messaging bot options configuration 402 for the client device based on the user intent 412. The messaging bot options configuration 402 configures one or more client devices with interface controls empowering the one or more users of the one or more client devices to engage with one or more messaging bots.

The bot management component 406 then sends the messaging bot options configuration 402 to the sender client device 302 in response to the change in the context of the messaging interaction enacted by the message being sent by the sender client device 302. Sending the messaging bot options configuration 402 to the sender client device 302 may comprise adding the messaging bot options configuration 402 to a message queue 314, such as a message queue 314 associated with a message thread in which the messaging interaction is occurring. The messaging bot options configuration is then distributed to the sender client device 302 by a messaging component 310 retrieving the messaging bot options configuration 402 from the message queue 314 and delivering it to the client messaging component 304. The messaging bot options configuration 402 may be distributed to every user and client device involved in the messaging interaction, such as every client device belonging to every participant in the message thread. As such, a recipient client device 316 for the message may also receive the messaging bot options configuration 402 generated in response to the message. In some embodiments, a messaging bot options configuration 402 may be distinctly configured for a primary client that initiated a messaging bot interaction and one or more secondary clients that are present in the message thread but did not initiate the messaging bot interaction.

A messaging interaction comprises a plurality of exchanged messages. This plurality of exchanged messages includes a most-recent message of the message interaction. A message package sent to the client device via the messaging component 310, with this message package associated with the most-recent message, may be used to deliver the messaging bot options configuration 402. A message package sent to the sender client device 302 may be used to confirm receipt of the message by the messaging system 112, may be used to report delivery of the message to one or more recipient users, and/or may be used to report that a recipient user has viewed the message. A message package sent to a recipient client device 316 may comprise both the message, as may be the initial delivery of the message to the recipient client device 316. In either case, the message package may additionally include the messaging bot options configuration 402.

In general, the message may be sent to every client device related to a message thread, including the client device used to send the message. This message may be augmented in the package used to deliver the message with the messaging bot options configuration 402. The messaging bot options configuration 402 configures the messaging interface for the messaging client in displaying a message thread with controls empowering interactions with a messaging bot. Therefore, the bot management component 406 is operative to send a message package to the client device, the message package associated with the most-recent message, such that the message package comprises the messaging bot options configuration 402. This message package updates the client device with the most-recent message. In some cases, this most-recent message is received from a different client device than the one receiving the message package. In some cases, the message package may acknowledge receipt of the most-recent message from the client device.

In some instances, the messaging bot options configuration 402 may be a messaging bot menu associated with a messaging bot. The messaging bot menu is customized based on the user intent 412. The messaging bot menu may consist of a plurality of user-customizable options. Customizing the messaging bot menu based on the user intent may consist of pre-filling one or more of the user-customizable options based on the user intent. The messaging bot menu may comprise a later stage or second stage of providing messaging bot options configurations to a client device, with a first stage being messaging bot options configurations and the second stage being a customized messaging bot menu provided in response to an activation of a messaging bot invocation control.

In some instances, the messaging bot options configuration 402 may consist of a plurality of messaging bot invocation controls. Each of the messaging bot invocation controls is associated with a different messaging bot. This plurality of messaging bot invocation controls is selected based on the user intent 412. The user intent 412 may reflect a user-expressed goal or subject of a messaging interaction. Various messaging bots may be associated with this user intent 412. For instance, messaging bots may be assigned one or more user intents during a registration with the consumer-to-business communication system 300. A plurality of messaging bots associated with the user intent 412 are determined and provided to a client device. In some instances, the plurality of messaging bot invocation controls may be additionally selected based on a user context. A user context may consist of one or more of a user location and a local user time, without limitation. The plurality of messaging bot invocation controls may additionally be selected based on a user profile, such as based on user service preference information stored in the user profile.

After the delivery of a messaging bot options configuration 402 comprising messaging bot invocation controls, the user of the client device may select one of the messaging bot invocation controls. The client messaging component 304 may then receive a user messaging bot selection of a selected messaging bot invocation control of the plurality of messaging bot invocation controls from the client device. A selected messaging bot invocation control is associated with a selected messaging bot. The user messaging bot selection is passed to the bot management component 406, which then sends a messaging bot interface to the client device in response. This messaging bot interface may comprise, in some instances, a messaging bot menu.

To process the messaging bot selection, the bot management component 406 sends a messaging bot invocation message to a bot server associated with the selected messaging bot. The messaging bot invocation message includes the user intent 412 to empower the messaging bot to configure itself according to the user intent 412. In some instances, the bot server may be hosted by the consumer-to-business communication system 400. In other instances, the bot server may be externally hosted, such as by the developer of the messaging bot. The bot management component 406 then receives a messaging bot interface specification from the bot server in response to the messaging bot invocation message, where this messaging bot interface is based on the messaging bot interface specification.

The messaging component 310 may instantiate a multiple-user interface on a plurality of client devices. The instantiating indicates display of a at least a portion of the multiple-user interface on each of the plurality of client devices. In response, a messaging client on each of the plurality of client devices displays at least a portion of the multiple-user interface. The messaging component receives a user-interface interaction from a first client device of the plurality of client devices and updates the multiple-user interface on the plurality of client devices based on the user-interface interaction. The client messaging component 304 may receive a multiple-user application initiation from an initiating client device of the plurality of client devices and instantiate the multiple-user interface on the plurality of client devices in response to the multiple-user application initiation.

A multiple-user application initiation may be associated with a message thread for a messaging system. The message thread may be associated with a plurality of participant user accounts, with the plurality of participant user accounts associated with the plurality of client devices. The multiple-user interface is instantiated on the plurality of client devices based on the plurality of participant user accounts being associated with the plurality of client devices for the plurality of participant user accounts in the message thread.

The client messaging component 304 may update the multiple-user interface on the plurality of client devices by distributing a user-interface update object based on the association between the plurality of participant user accounts and the message thread. The user-interface update object may be distributed using a message queue 314, with the object queued for distribution to the plurality of client devices.

An initiating client device may be associated with an initiating user account of the plurality of participant user accounts. The initiating user account may be used as a primary account for interaction with a bot, where a requested service is requested as being a request from the initiating user account. The client messaging component 304 may receive a service request via the multiple-user interface, the service request comprising input from the plurality of participant user accounts, and submit the service request to a messaging bot. The service request is submitted by the initiating user account as being associated with the initiating user account. The service request is sent to the messaging bot as originating with the initiating user account.

The plurality of participant user accounts may comprise the initiating user account and one or more contributor user accounts other than the initiating user account. The input comprising the service request may comprise a group service configuration from the initiating user account and one or more individual service configurations from the one or more contributor user accounts. For instance, each participating user may indicate a particular portion of the service they'd like to receive. For example, a participating user may select a food order, transportation order, or other service order. As such, the one or more individual service configurations may comprise one or more option selections. Alternatively, the one or more individual service configurations may comprise one or more service-request participation confirmations, such that a participant count for a requested service is determined based on the one or more service-request participation confirmations.

A multiple-user application may be used to generate a service request with an associated cost. In some cases, the client messaging component 304 may receive a cost-split request from the initiating user account and send the cost-split request to the one or more contributor user accounts. The cost-split request may be sent via the message queue 314. The cost-split request may be operative to initiate a financial transfer from the one or more contributor user accounts. In some instances, the financial transfer may be used to reimburse the initiating user account. Alternatively, the financial transfer from one or more participant user accounts may be pooled to pay for the requested service.

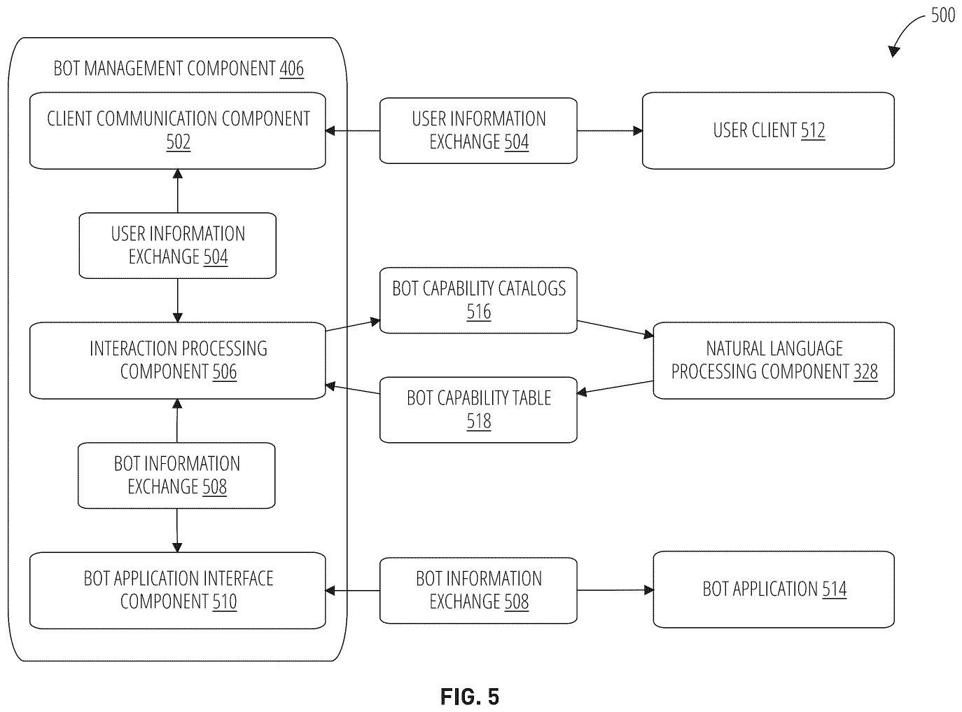

FIG. 5 illustrates an embodiment of a consumer-to-business communication system 500 determining a messaging bot options configuration 402 based on a user information exchange 504 and a bot information exchange 508.

The user-to-bot conversation may be mediated by a bot management component 406. The bot management component 406 may be coupled to messaging servers for a messaging system 112. The messaging servers may perform the sending and receiving of messages between the bot management component 406 and the user client 512. The messaging servers may perform the sending and receiving of information between the bot management component 406 and the bot application 514, or a bot-application front-end may be used, such as business portal 116.

A user client 512 may comprise a messaging client, a dedicated client for access to the bot application 514 or a plurality of bot applications for a plurality of bots 108a . . . , or any other client including messaging functionality. The user client 512 may execute on the client device. The user client 512 may engage in a user information exchange 504 with the bot management component 406 using a client communication component 502. The client communication component 502 may provide a client front-end to the bot management component 406, which may be mediated by the transmission of messages by a messaging system 112. The user information exchange 504 may comprise the sending of user-composed messages from the user client 512 to the bot management component 406 and the sending of bot messages from the bot management component 406 to the user client 512. The user information exchange 504 may further include additional user information in addition to user messages, such as, without limitation, social-networking information for one or more users, bot interaction history information for one or more users, or other user information.

A bot application 514 may comprise a software program, such as may execute on a developer computer system or may be hosted by the consumer-to-business communication system 500. The bot application 514 may engage in a bot information exchange 508 with the bot management component 406 via a bot application interface component 510. The 510 may act as a front-end to the bot management component 406 and/or messaging system for bot applications. The bot information exchange 508 may comprise the submission of example conversations to the bot management component 406 and the performance of bot API calls by the bot application interface component 510 with the bot application 514. The bot information exchange 508 may comprise the submission of a bot capability catalog to the bot management component 406 and/or other information exchange for the selection of a bot for suggestion to a user.

The bot application interface component 510 receives a plurality of bot capability catalogs 516 for a plurality of bots at a bot-service system. The bot-service system may comprise a component of a messaging system 112. The bot capability catalog for a particular bot application 514 may be received as at least part of a bot information exchange 508 with that bot application 514. The bot application interface component 510 provides the bot capability catalogs 516 to the interaction processing component 506 as part of a bot information exchange 508 for each of the bots.

Each of the plurality of bot capability catalogs 516 expresses bot capability in natural language for an associated bot. A particular bot is built to provide a particular service or set of services. These services may be expressed in natural language, such as English, Spanish, or any other language. These services may use natural language to describe in human-readable terms what service or services the bot may provide to the user. Various human-readable bot capability descriptions may be used. For example, a developer may describe a food-delivery-ordering bot with the sentence “This bot can help find and order food for delivery in the San Francisco area.” One or more of the plurality of bot capability catalogs 516 may express bot capability in one or more example user prompts. An example user prompt is an example of a user statement, user interaction, or other user behavior that the developer indicates should prompt an interaction with the bot, such as suggesting the bot to a user. For example, an example user prompt may be the human-readable natural-language sentence, “What do you think about ordering something in?” As illustrated in the example sentence, an example user prompt may comprise a portion of a user-to-user exchange, such that a user may be suggested bots to accompany the natural flow of their conversation with one or more other users.

The bot application interface component 510 may receive one or more bot capability catalogs of the plurality of bot capability catalogs 516 via a developer bot-configuration interface. As such, the natural-language expression of the bot capabilities may be developer-written bot capability descriptions. Further, the developer-written bot capability descriptions may be developer-written example user prompts. In some cases, a developer may receive logs of user interactions with their bot. The developer may then mark a user prompt as an example user prompt that should, moving forward, be used as an example of a user statement that should prompt interaction with the bot. As such, at least some bot capability descriptions may be developer-approved user-generated example user prompts. In some cases, a developer may edit a user-generated prompt before using the user-generated prompt as an example user prompt for the bot.

The client communication component 502 receives a user service prompt from a user client device. A user service prompt is any indication in relation to a user that it may be appropriate to suggest a bot to the user. The user service prompt may be expressed in natural language. This natural language may comprise written text, spoken word, visual gestures or signs (e.g., sign language), or any other use of natural language. In some cases, the user prompt may be received via a messaging client on the user client device. The user prompt may comprise a portion of an interaction between two or more users. This interaction may comprise a messaging interaction performed using a messaging client.

In some cases, the user prompt may comprise a bot interaction result. A bot interaction result is the result of an interaction between one or more users and one or more bots. For example, a user making a restaurant reservation via a bot is a bot interaction result. A bot interaction result may be recognized as a user prompt in order to encourage chains of interactions with bots. For instance, a user may be suggested transportation-service bots in response to a bot interaction result of making an appointment, reservation, or other plan to travel to a particular location. For example, in response to a restaurant reservation being made via a bot, the user may be suggested a ride-sharing bot without any other user action (such as expressing a specific interest in transportation) by the user.

The interaction processing component 506 determines one or more selected bots of the plurality of bots by matching the user service prompt against the plurality of bot capability catalogs 516. In some cases, the consumer-to-business communication system 500 may be configured to, where possible, suggest multiple bots to provide options to the user. As such, the interaction processing component 506 may determine two or more selected bots of a plurality of bots.

The client communication component 502 then identifies the one or more selected bots to the user client device in response to receiving the user service prompt from the user client device as part of the user information exchange 504. The one or more selected bots may be identified to the same messaging client on the user client device that was used to detect the user prompt.

The interaction processing component 506 may use a natural language processing component 328 to match natural-language user prompts to natural-language bot capabilities. The interaction processing component 506 submits the bot capability catalogs 516 to the natural language processing component 328 and receives a bot capability table 518 from the natural language processing component 328 in return. The interaction processing component 506 submits the user prompt to the natural language processing component 328 and receives a user intent from the natural language processing component 328 in return. The interaction processing component 506 then determines the one or more selected bots by comparing the user intent to the bot capability table.

This comparison may be performed using numerical vectors that represent an inferred meaning of a natural language expression in an abstracted numerical form. The bot capability table 710 may represent the plurality of bot capability catalogs as a plurality of bot capability vectors. The plurality of bot capability vectors encode the natural-language bot capabilities in an abstracted numerical form. In some embodiments, each bot may be represented by a single bot capability vector, such that even a plurality of natural-language bot capability expressions are combined into a single numerical vector. However, in other embodiments, bots may be represented by multiple vectors, such as by having a distinct vector for each of a plurality of bot capability expressions (e.g., a plurality of example user prompts) in the bot capability table 518. The translation from natural-language bot capabilities to non-natural-language bot capability vectors is performed by the NLP component 560 using natural-language-to-vector techniques.

Similarly, the user intent may represent the user prompt as a user intent vector. The translation from a natural-language user prompt to a non-natural-language numerical vector is performed by the natural language processing component 328 using natural-language-to-vector techniques.

Comparing the user intent to the bot capability table 518 therefore may comprise performing a similarity search of the plurality of bot capability vectors based on the user intent vector. The interaction processing component 506 may search the bot capability table 518 using the vectorized user intent as a search term. The similarity search may be based on a cosine similarity comparison. The bot capability table 518 may be organized to empower efficient cosine similarity comparisons, such that the plurality of bot capability vectors are searched without a direct cosine similarity calculation being performed between all of the plurality of bot capability vectors and the user intent vector. The interaction processing component 506 selects one or more bots based on the similarity search determining that the one or more bot capability vectors for the one or more bots are similar to the user intent vector.

The interaction processing component 506 may select a predefined number of bots by selecting the predefined number of bots with bot capability vectors with the highest similarity to the user intent vector. Alternatively, the interaction processing component 506 may select a selection of bots by selecting those bots with bot capability vectors that exceed a predefined similarity threshold to the user intent vector. These techniques may be used in combination, such as by selecting those bots with bot capability vectors that exceed a predefined similarity threshold to the user intent vector without exceeding the predefined number of bots, such that if more bots exceed the predefined similarity threshold than allowed by the predefined number, the predefined number of bots with the highest similarity to the user intent are selected. As such, the selected bots may be those that exceed the predefined similarity threshold up to the predefined number of bots. The selected bots may be ranked for display on a client device according to the degree of similarity, with higher-similarity bots ranked higher than lower-similarity bots.

In some embodiments, the selected bots may be filtered based on user-specific information to improve the selection and ranking of bots for a specific user. As such, the interaction processing component 506 may determine two or more filtered bots of the two or more selected bots based on bot relevancy and identify the two or more filtered bots to the user client device in response to receiving the user service prompt from the user client device. Bot relevancy corresponds to the predicted relevancy of a particular bot to a particular user. Filtering the selected bots for bot relevancy to a particular user, or to the plurality of users in a message thread, addresses the particular preferences of a user or users so as to improve the individual experience of the particular users as compared to performing recommendations uniformly across the user base of a consumer-to-business communication system 500.

The interaction processing component 506 determines the bot relevancy for the two or more suggested bots to determine one or more filtered bots. Determining bot relevancy may be based on one or more signals, such as, without limitation, user profile information, user behavior information, user location information, user messaging context information, and user bot history information. The client communication component 502 may retrieve user information for use in analyzing the signals and provide the user information as part of the user information exchange 504.

User profile information may include a variety of different types of information. User profile information may include demographic information. User profile information may include relationship information. User profile information may include education and/or occupational information. User profile information may include preference information, such as user-generated information indicating a user's favorite media, services, or other preferences. As such, the user profile information may include user service preference information in the user profile for a user.

Bots may be empowered to provide bot ranking information relevant to ranking the bots to the consumer-to-business communication system 500 to aid the consumer-to-business communication system 500 in ranking the bots. A bot may be provided with information describing a user service prompt and/or the one or more users prompting an offer of one or more bots. The bot is allowed to analyze this information and provide bot ranking information indicating its own analysis of whether it is appropriate for responding to the user service prompt and/or providing service to the one or more users. The bot may be encouraged to provide an honest and accurate assessment by penalizing bots that provide bot ranking information indicating that they should be highly ranked, but who are then poorly received by users. In general, the bot may be encouraged to provide an honest and accurate assessment by rewarding bots that provide bot ranking information that positively corresponds to user reception of the bot and by punishing bots that provide bot ranking information that poorly corresponds to user reception of the bot. User reception of the bot may comprise one or more measures of user response to a suggested bot, such as, without limitation, a bot being selected for use, a user using a bot to receive a service, and user satisfaction with a service received from a bot or some other element of a bot experience.

The interaction processing component 506 queries the two or more filtered bots for bot ranking information and ranks the two or more filtered bots based on the bot ranking information. The ranking of the filtered bots may determine which of the filtered bots are displayed for one or more users and/or the order in which the one or more filtered bots are displayed for the one or more users. The ranking bot information may contribute to the determination of a ranking order for the filtered bots. A highest-ranked groups of filtered bots may be provided to one or more client devices for display and ordered for display based on the ranking order of the provided filtered bots. The bot ranking information may comprise at least a portion of the bot information exchange 508. The bot ranking information may comprise a numerical score generated by the bots, with the numerical score contributing to a ranking number for each bot through a mathematical combination of multiple factors including the numerical score.

In some cases, a bot may be provided with user information for a user to aid it in generating the bot ranking information. Querying the two or more filtered bots for the bot ranking information may comprise providing user information for a user account, where the user service prompt is associated with the user account for the bot-service system. The user information may comprise user profile information, such as may include demographic information and user-interest information. The user information may comprise user-service-preference information. The user information may include location information, which may be particularly of use for bots that relate to service that include a physical component, such as for food delivery or transportation.

User information is kept secure by the consumer-to-business communication system 500 and, as such, permission from a user to share user information may be required before the information is shared. As such, the interaction processing component 506 may determine a user-information share setting for a bot of the two or more filtered bots and request a user-information share permission from the user account based on the user-information share setting and the determining of the bot as a filtered bot. A user-information share permission is a permission for user information associated the user account to be shared with third parties. Such a permission may be required before information is shared with third parties. In some embodiments, permission to share information with third parties may be asked and received for all bots using the consumer-to-business communication system 500, such that permission is granted to share certain information in general when determining suggested bots. Alternatively, in some embodiments, permission to share information with third parties may be asked and received for a specific bot, such that permission to share user information is requested from the user for that specific bot and a received permission is only for that specific bot. As such, in these embodiments, a user may be asked for further permission to share information with other bots.

In one case, the filtered bots may include an account-based bot. An account-based bot is a bot where use of the bot to receive a service uses a user account in addition to the user account used for the consumer-to-business communication system 500. For example, the user may have a messaging account for a messaging system 112 and then a distinct user account for use with a ride-sharing bot. While these accounts may be linked to each other to ease use of the service with the consumer-to-business communication system 500, they represent distinct registrations of the user with distinct systems. In this case, the user information provided to the account-based bot may comprise account information for the account-based bot, such as account information for a service associated with the account-based bot. For example, a ride-sharing bot associated with a ride-sharing service, such as may also be represented by a ride-sharing application on a user client device.

The bot-service system may be operative to chain user interactions with agents such that one interaction with an agent produces additional suggestions that can lead into an additional agent, with this pattern potentially continuing indefinitely. An agent may comprise any entity operative to interact with a message thread in service of the participants in the message thread. Agents may comprise one or more of one or more messaging bots, one or more multiple-user applications, one or more messaging client tools, and one or more social-networking tools. A messaging client tool may comprise a messaging client feature operative to provide a service to a message thread based on user input and producing a result for the message thread. A social-networking tool may comprise a messaging client feature operative to provide a service based on social-networking information and/or generating social-networking information for a message thread.

An agent may comprise a multiple-user poll tool. A multiple-user poll tool may provide a pool on multiple client devices that collects a selection from the client devices and provides a group selection based on the individual selections from the client devices in the message thread. A multiple-user poll comprises a plurality of options. In some cases, the options of a multiple-user poll tool may be configured by a primary user, with the primary user and one or more secondary users—collectively comprising the participants in a message thread—then voting on those options, with the result of the multiple-user pool comprising the majority or plurality selection from among the options. In some embodiments, the consumer-to-business communication system 500 may configure the one or more options automatically. The automatic configuration of options may be based on one or both of messaging interaction information and bot information from a messaging bot. Bot information from a messaging bot may comprise messaging bot configuration options. Messaging bot configuration options may comprise options available for configuring a messaging bot for the configuration of a service to be provided by the messaging bot.

Chaining user interactions with agents may be based on the agents subscribing to particular events. Events include, but are not limited to, a result being produced from an interaction with a message thread. The interaction processing component 506 may receive a plurality of agent-event subscriptions for a plurality of agents at a bot-service system as part of a bot information exchange 508. An agent is subscribed to one or more events as part of the configuration of the agent for use with the consumer-to-business communication system 500. For instance, a messaging bot may be subscribed to various events as part of a developer configuration of the messaging bot.

The interaction processing component 506 detects an event associated with a user account. This user account associated with a user client device. The interaction processing component 506 matches the event against the plurality of agent-event subscriptions to determine one or more event-response agents and identifies the one or more event-response agents to the user client device in response to detecting the event. The event-response agents may be identified to the user client device as a plurality of suggested agents available for selection by the user.

An event may comprise one or more of a user service prompt, a social-information update for the user account, and a user context change for the user account. A user service prompt may comprise a detected interest in engaging in an agent-based service in an interaction between two or more users. A social-information update may comprise, without limitation, one of a relationship status change and a friend addition. A user context change may comprise, without limitation, a user location change. An event may comprise a bot interaction result. A user location change may correspond to a arriving on a particular city block, arriving in a particular city, or any other user location change.

The event may be detected based on a portion of an interaction between two or more users. For instance, the consumer-to-business communication system 500 may perform a multiple-user poll tool, receive a multiple-user poll result from the multiple-user poll toll, and generate a subsequent event for the interaction based on the multiple-user poll result. A subsequent event may be matched against the plurality of agent-event subscriptions to determine one or more additional event-response agents. These additional event-response agents may then be identified to the user client device in response to detecting the subsequent event. The event may be detected according to event information. The event information may be received via a messaging client on the user client device, with the one or more event-response agents identified to the messaging client on the user client device. Event information may comprise, for example, planned attendance at a particular location for a particular event.

A natural language processing component 328 may comprise a natural-language machine-learning component, such that the natural language processing component 328 is operative to improve its performance using machine-learning techniques. The interaction processing component 506 may therefore teach the natural-language machine-learning component based on a bot interaction history for the bot-service system.

In some embodiments, a taxonomy may be used for an initial period of a bot-service system and then replaced with a machine-learning based matching between bot capabilities and service prompts. A taxonomy may comprise a human-generated taxonomy that represents bot capabilities according to a defined taxonomy, with the interaction processing component 506 matching user prompts against the bot capabilities based on the defined taxonomy using techniques for defined taxonomies. The interaction processing component 506 may perform a plurality of taxonomy-based bot selections for the bot-service system to generate at least a portion of the bot interaction history.

The consumer-to-business communication system 500 may iteratively improve its performance by using machine learning based on its ongoing experience with suggestions bots to users. The bot application interface component 510 receives a plurality of bot capability catalogs for a plurality of bots at the bot-service system. Each of the plurality of bot capability catalogs expresses bot capability in natural language for an associated bot. The client communication component 502 receives a plurality of user service prompts from a plurality of user client devices, the plurality of user service prompts expressed in natural language. The interaction processing component 506 determines selected bots of the plurality of bots for each of the plurality of user prompts by matching the plurality of user service prompts against the plurality of bot capability catalogs using a bot capability table 518 generated by a natural-language machine-learning component.

The client communication component 502 provides the selected bots to the plurality of user client device in response to receiving the plurality of user service prompts. The interaction processing component 506 records a bot interaction history based on user interactions with the selected bots and then updates the natural-language machine-learning component based on the bot interaction history. The interaction processing component 506 gathers signals related to the performance of the bots based on the bot interaction history.

The interaction processing component 506 may update the natural-language machine-learning component based on optimizing for bot completion rate. Bot completion rate may correspond to the rate at which users complete an interaction with a bot. An interaction with a bot is completed where the interaction produces a result for the user. Optimizing for bot completion rate may be based on user bot dismissal rates. Optimizing for bot completion rate may be based on maintaining a user bot dismissal rate below a defined bot dismissal threshold. Optimizing for bot completion rate may be based on user-bot-history signals. User-bot-history signals indicate information about the interactions between users and bots. Where the bot capability table represents the plurality of bot capability catalogs as a plurality of bot capability vectors, the interaction processing component 506 may update the natural-language machine-learning component to modify the mapping between the plurality of bot capability catalogs and the plurality of bot capability vectors.

In some embodiments, the interaction processing component 506 may update the natural-language machine-learning component based on increasing bot information sharing. Bots which produce a result but do not share information about the result using formal information-reporting signals to the bot-service system may be penalized by having their rank in the suggested bots lowered. Similar penalization may be performed where a bot receives user information in the configuration of a service but does not provide that user information to the bot-service system. In contrast, bots may be rewarded with higher ranking where they provide information to the bot-service system, such as user information about a user determined during the configuration of a service.

### Proactive and Reactive Bots

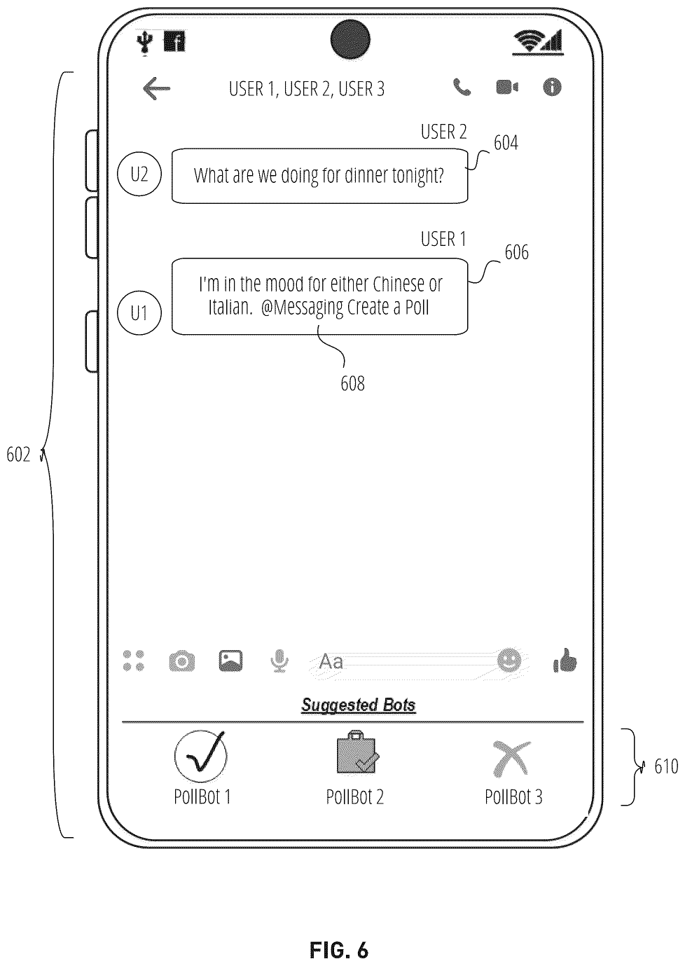

In some embodiments, these suggestions may be provided reactively, in response to an express invocation of a bot, service, or capability. For example, FIG. 6 depicts an exemplary interface 602 for a messaging application in which a participant in a group conversation expressly invokes a suggestions interface. In this example, conversation participant User 2 sends a first message 604 into the conversation, asking what time the conversation participants would like to go to dinner. Conversation participant User 1 responds with a second message 606, which includes an invocation 608 asking the messaging service to “create a poll.”

The invocation 608 may serve as a trigger asking the messaging service to provide suggestions of bots or bot features that can respond to the invocation 608. The invocation 608 may be self-contained in a dedicated message or, as shown in FIG. 6, may be a part of a larger message.

The invocation 608 may be expressed in natural language, as opposed to traditional invocations that tend to have a specified format and/or predefined commands or keywords. A machine learning (ML) natural language processor (NLP) may process the invocation 608 and determine an intent of the invocation 608 (e.g., initiating a poll). The intent may come from a predefined list of intents that an ML NLP intent classifier model is trained to recognize. The classifier model may generate outputs for some or all of the intents, where the outputs include respective confidence scores (e.g., expressed as percentages) indicating a confidence that the intent corresponding to the confidence score is the intent reflected in the invocation 608.

The intent may be compared to a list of predefined intents that are mapped to particular bots capable of serving those intents, and/or the messaging service may look up bots in a bot catalog using the intent as a search term.

The messaging service may select a number n of bots capable of servicing the intent, and display the selected bots in a suggested bots interface element 610. The number n of selected bots may depend on the size of graphical elements (e.g., icons) associated with the bots, and the available screen real estate (ensuring that the suggested bots interface element 610 does not become overcrowded). Thus, the number n of selected bots may vary depending on the device and/or device settings (e.g., resolution, orientation, etc.) on which the suggested bots interface element 610 is displayed. In some embodiments, the suggested bots interface element 610 may be a horizontally scrolling list, which allows a user to scroll through list items that would otherwise not fit on a single screen.

In some embodiments, selecting one of the bots displayed in the suggested bots interface element 610 may cause the messaging service to invoke the bot, which adds the bot as a conversation participant and allows the bot to communicate with the members of the group engaging in the conversation. In others, tapping on a suggestion or invoking the bots suggestion system may cause a single, centralized entity to be added to the conversation. The single entity may be capable of interfacing with many different bots to provide the capabilities of the bots in the conversations, although the conversation participants may continue to interact only with the centralized entity.

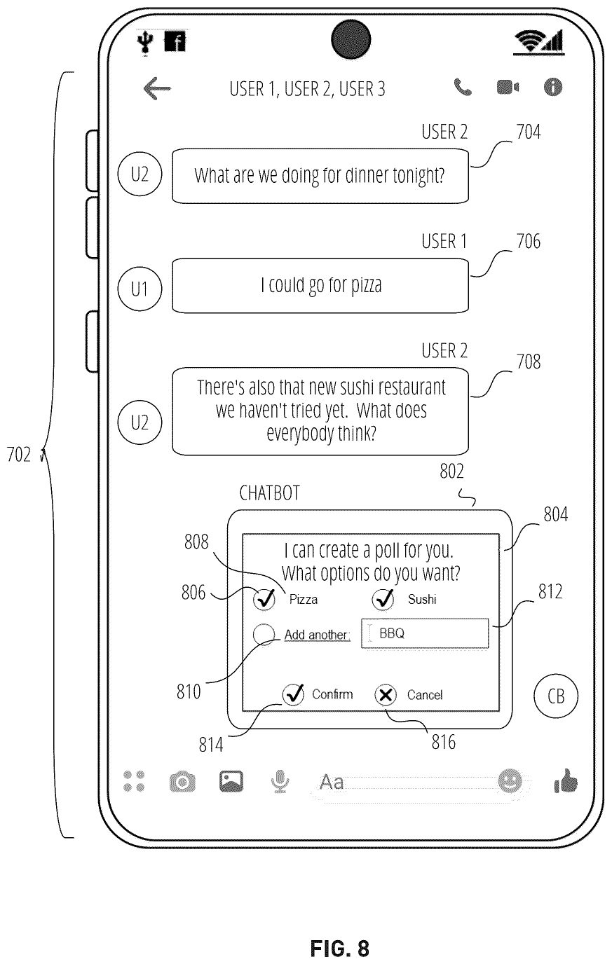

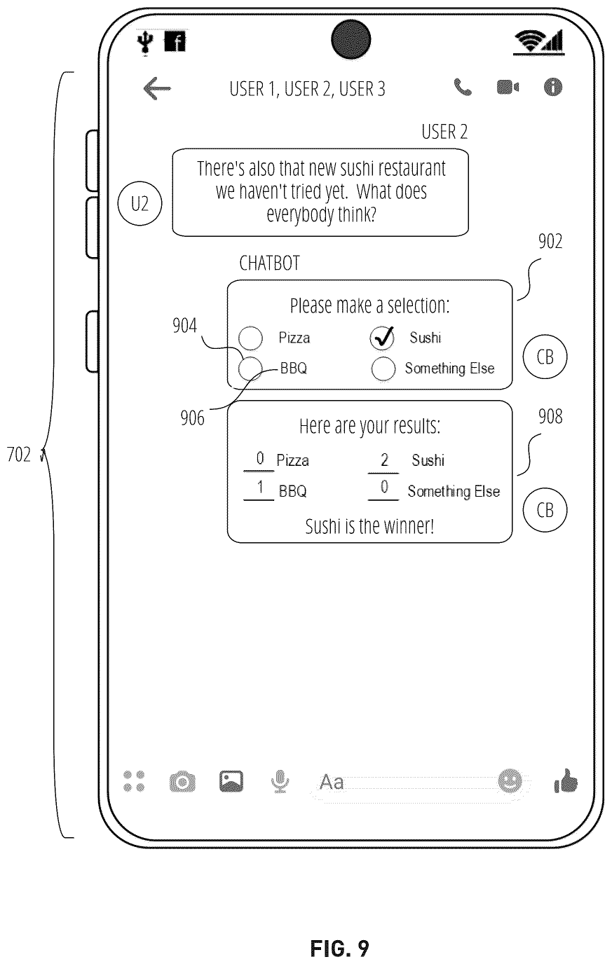

In some embodiments, the bot may trigger a mini-app in the conversation (see FIG. 8 and FIG. 9) in order to perform initial setup of the bot capabilities. In contrast to a typical message, a mini-app included in a conversation may include interactable elements allowing the bot to be configured for a particular task. This mini-app may be viewed by all participants in the conversation, or only the user who invoked the bot. The mini-app may be dynamic, and hence its appearance may change over time. For example, a bot may send a message into a conversation with a mini-app that allows a poll to be set up (see FIG. 8). After the poll is configured, the appearance of the mini-app may change to display the poll in the same message or a replacement message taking the same location in the conversation as the original message (FIG. 9).

The n bots selected for display in the suggested bots interface element 610 may be the top n bots in a ranked list of bots capable of servicing the intent. The bots may be ranked based on a ranking score which may account for (e.g.) how well the bot is able to service the intent, user preferences (such as whether the user has used the bot before, or a bot from the same provider), bot popularity etc. The n selected bots may be displayed in a ranked order in the suggested bots interface element 610.

The ranking score may be different for the different participants in the conversation. Accordingly, different bots may be displayed in the suggested bots interface element 610 on different user devices.

In some embodiments, the suggested bots interface element 610 is not displayed. Instead, the top bot may be selected and automatically invoked by the messaging service. The decision as to whether to make suggestions or to simply invoke the bot outright may depend on the identified intent, the nature of the bot, and/or user preferences. For example, if the intent indicates a desire to create a poll, and the user has never created a poll before, options may be presented in the suggested bots interface element 1408. On the other hand, if the intent indicates a desire to add a graphical element (such as a sticker or emoticon) to a message, a corresponding stickers bot may be automatically invoked to provide the user with this option.

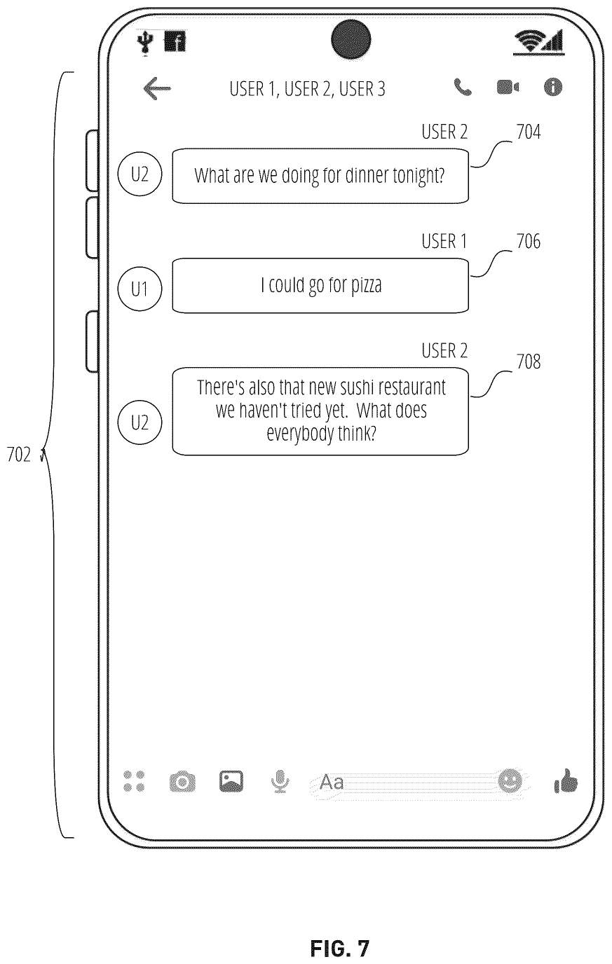

As an alternative or addition to the reactive capabilities described above, the messaging system may proactively offer bot suggestions. FIG. 7 depicts an exemplary interface 702 for a messaging application in which the messaging service proactively offers a suggestion without an express invocation.

In this conversation, participants User 1 and User 2 have exchanged a first message 704, a second message 706, and a third message 708. None of the messages includes an express invocation of the bot capabilities. Nonetheless, the messaging service may dynamically analyze the messages (alone or together) using a natural language processor to determine an intent of the messages (much like the intent determination that was done for the reactive scenario).

Because the system is not responding to an express invocation, in some embodiments the system may not act unless the intent to invoke the suggestion capability is relatively clear. For example, when generating confidence scores for the intents as discussed above, the system may refrain from invoking the suggestions capabilities unless the highest confidence score exceeds a predefined threshold value (e.g., 60%). The predefined threshold value may be tuned by administrators of the messaging service and/or the conversation participants in order to make the system more or less likely to offer proactive suggestions.

If the confidence score exceeds the predetermined threshold, the suggested bots interface element 610 may be displayed, or a particular bot may be automatically invoked, as discussed above.

In either the proactive scenario or the reactive scenario, conversation context may be considered when performing the initial invocation of the bot. For instance (as will be described in more detail in the examples below), information from the conversation's messages may be propagated to the bot to specify input parameters. Moreover, meta-information about the conversation (e.g., the location of the conversation participants as the participants may have shared with the system such as through their user profiles, participant preferences, etc.) may also be used to initialize the bot and specify options for input parameters.

These suggestions capabilities may be used for suggesting bots capable of serving any predefined intent. A few examples of such intents and bots are illustrated with respect to FIG. 8 through FIG. 14.

FIG. 8 depicts an example of a polling mini-app presented in an interface 702. In this example, a message from User 2 has caused the messaging system to proactively invoke the bot suggestion capability. A chatbot associated with the messaging system sends a bot message 802 into the group conversation. In some embodiments, the bot message 802 may be visible to all conversation participants; in others, the bot message 802 may be visible to only a subset of users, such as the user whose message triggered the invocation of the suggestion capability (e.g., User 2 in this example) or multiple users whose messages contributed to the determination that a proactive suggestion should be offered. In this example, the system has determined that the users' intent was to start a poll, selected the highest-ranked polling bot in the bot catalog, and automatically invoked the bot. In other embodiments, a similar scenario might cause the suggested bots interface element to be displayed.

The bot message 802 may include a mini-app 804 that allows the poll settings to be configured. Although the mini-app 804 in FIG. 8 is illustrated with a border in the bot message 802, this is not necessary. The mini-app 804 may appear as a normal part of the bot message 802 (e.g., without distinguishing marks such as a border). Nonetheless, the mini-app 804 may differ from other parts of the bot message 802 in that users can interact with the mini-app 804.

Alternatively or in addition, the mini-app 804 may appear in the conversation separately from any message. When the user configures the mini-app 804, the mini-app 804 may disappear from the conversation, and the corresponding bot may use the provided information to send a bot message 802 into the conversation (or to update the mini-app 804, or to cause a different mini-app 804 to appear).

A polling bot may need to know which options to include in the poll. Traditionally, this might be done by specifying the options as part of an invocation of the polling bot (e.g., “@PollBot startpoll: pizza; sushi; BBQ”). According to exemplary embodiments, however, some or all of the options may be retrieved from the messages of the conversation. For example, the conversation shown in FIG. 8 is a continuation of the conversation in FIG. 7. The natural language processor may evaluate the messages of the conversation to identify options consistent with the intent. In this example, the users intended to create a poll, and mentioned several food options that could be suitable for use in the poll (pizza and sushi). Accordingly, the polling bot propagates initial options 808 for the poll including “pizza” and “sushi.”

These initial options 808 may be changed, and more options may be added, through the mini-app 804. For example, selection elements 806 may be associated with each of the options 808. By unchecking the selection elements 806, the user can exclude some of the suggested options from the poll. Moreover, an addition element 810 allows a user to specify (e.g. in an input interface 812 configured to receive an input representing a new option), additional options to be included in the poll. As additional elements are added via the addition element 810, corresponding options 808 and selection elements 806 may be added in the mini-app 804.

The mini-app 804 may further include a confirmation element 814 and a cancelation element 816. By selecting the cancelation element 816, the user can cancel the invocation of the bot and cause the mini-app 804 to be closed. By selecting the confirmation element 814, the user can trigger the bot to send a poll with the specified options into the conversation., as shown in FIG. 9.

As can be seen in FIG. 9, the mini-app 804 from FIG. 8 has been replaced by a poll in a message 902. In some embodiments, this poll may be included in the same message 902 that the mini-app 804 was provided in, and the mini-app 804 may be updated with an interactable poll. In others, a new message may be sent into the conversation. In still others, the poll may appear in a mini-app separate from any conversation messages.

The poll may include a number of options 906 and corresponding selectable elements 904. Each member of the conversation may view their own version of the poll message 902, and may make a selection within the mini-app of the message 902.

In some embodiments, the poll may be associated with a timer; after the timer expires, any selections in the poll message 902 may be taken as final and the results of the poll may be tabulated and displayed in a poll results message 908. In some embodiments, users may change their minds and alter their selection in the poll results message 908, even after the poll results are tabulated. The poll results message 908 may be updated with the new results. In some embodiments, the poll results message 908 may be displayed immediately or in conjunction with the message 902, and the results may be updated each time a user makes a selection in the message 902.

### Shared Group Bots

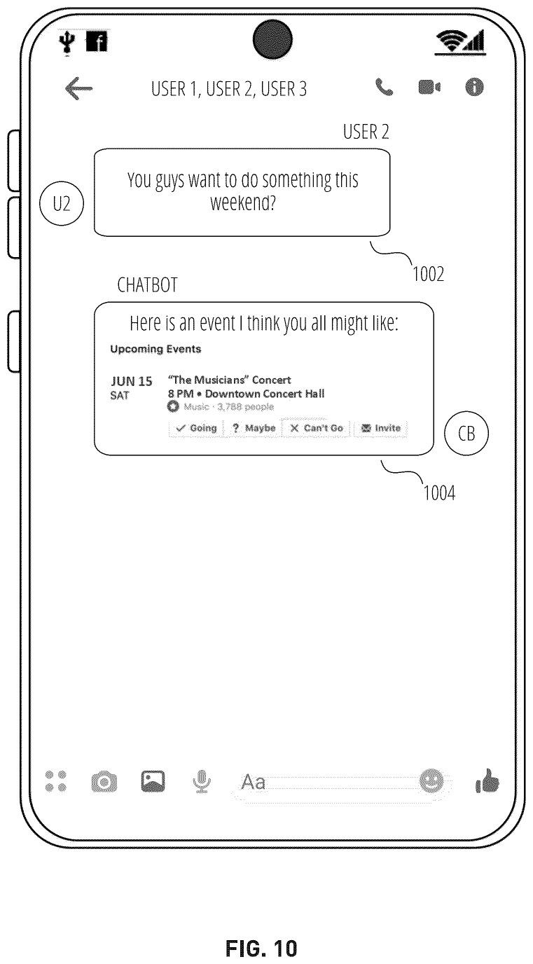

As noted above, some embodiments provide shared group bots that provide shared capabilities among all the participants of a conversation. FIG. 10 depicts one example of an event recommendation bot that suggests events that a group may collectively be interested in attending.

In this example, an invoking message 1002 is transmitted into the conversation. The invoking message 1002 includes natural language whose intent is to receive suggestions of an event going on in a particular timeframe. The messaging system may recognize this intent, as described above, and trigger a group bot configured to provide suggestions based on the group's interest. The group bot is triggered or invoked from within the conversation and provides its recommendation in the same interface as the conversation (in this example, in an event message 1004 transmitted into the conversation). The invoking message 1002 may serve as a user service prompt, as previously described.

To determine events that may be of interest to the group, the bot may receive sharable information about the group participants. In this example, shareable information that may be pertinent to the intent of receiving event recommendations may include the participants' schedules (so that the bot can select an event that occurs at a time the participants are available), the participants' interests (so that the bot can select events that the group members will enjoy participating in), any events that conversation participants are already attending (which, if they are determined to be of interest to other conversation participants, may be selected as a candidate for a group event), events that conversation participants have attended in the past or are scheduled to attend in the future (so that the bot can recommend similar events), the users' locations (so that the bot can select events that are reasonably nearby), and other information from which the participants' interests may be derived.

This information may be retrieved from the messaging system, a related social networking system, or other apps or services that the user links to the messaging system (e.g., calendar services, music streaming services, etc.). A user's interests might also be derived from the shareable information; for instance, if the users links a music streaming service to the messaging service and the music streaming service indicates that the user often streams songs by the Beach Boys, the bot may be able to deduce that the user is fan of beach rock.

The bot may examine the shareable information and identify common interests between the conversation participants. If the shareable information comes from a social network, for example, the bot may determine if the participants have interacted with, or have an association with, any common nodes in the social graph (see FIG. 2). If the users have supplied their own list of interests (e.g., in a profile with the messaging system or elsewhere), these interests may be processed by a natural language processor to identify interests that may mean the same, or similar things (e.g., if one user indicated an interest in “ships” and another indicated an interest in “sailing,” the natural language processor may be able to identify that these two interests are substantially similar). An interest may also be predicted based on the interests of the user's friends or affiliates in the social network, based on the idea that closely-affiliated users likely share common interests. Still further, the user's available (e.g., publicly visible) comments or posts may be analyzed by a natural language processor to identify the user's feelings about certain topics (e.g., the user might have interacted with a particular concept node in a social network, which might otherwise indicate an affinity for the concept; however, if the user's interaction was to post a negative comment about the concept, it is more likely that the user is not interested in the concept).

The bot may access a list of upcoming events, which may be retrieved from a social networking service, local news sources, dedicated event calendars, etc. If the events in the list are categorized, then the bot may retrieve those categories in which it has determined the conversation participants have common interests. If the events are not categorized, a natural language processor may be used to categorize the events in the list. The event list may also be filtered based on the users' availability, so that events that the users will not be able to attend are not considered.

When the bot has assembled a candidate list of events that may be of interest to the users, the candidate list may optionally be sorted and/or ranked. For example, the bot may assign a probability or score to each event based on the degree or extent of each group member's predicted interest in the event (as determined, e.g., by a machine learning algorithm and/or by an affinity score or other representation of interest in a social network). In some cases, the bot may also take into account negative preferences (e.g., the extent or degree to which a user would not be interested in attending the event).

In some cases, a score may be elevated based on synergies in the group. For instance, a first user may be very interested in seeing a superhero movie, and mildly interested in attending a comic book convention. A second user may be very interested in going to a rock concert and mildly interested in the comic book convention. However, the first and second user may have attended comic book conventions together in the past and have enjoyed the experience together. The users' shared affinity might indicate that they would have a good time attending the comic book convention together, even if their separate affinities for superhero movie sand rock concerts would otherwise cause these events to be ranked higher.

After the events are ranked or scored, the top n events may be selected. In some embodiments, n=1 such that only the highest-ranked event is suggested. In other embodiments, n may be a predetermined number (e.g., 3). In still further embodiments, n may be dynamically determined. For instance, if the bot is unable to determine an event that the users will enjoy with a high degree of certainty, the bot may present more options for the users to choose from; on the other hand, if the bot determines that the users are highly likely to be interested in a few events, then only those events might be presented. In other embodiments, the bot may set a cutoff interest threshold: events scoring above the threshold may be presented to the group, while events below the threshold are not.

After the event or events are selected based on the shareable information from the group participants, the bot's recommendation may be presented to the group. The recommendation may be presented in an event message 1004 that includes pertinent information about the event (e.g., date, time, location, and a brief description), in a mini-app as described above, or elsewhere in the same interface in which the conversation messages are presented. The recommendation may include a link to a page about the event, such as the event's page in a social network, a webpage for the event, a calendar item for the event, etc.

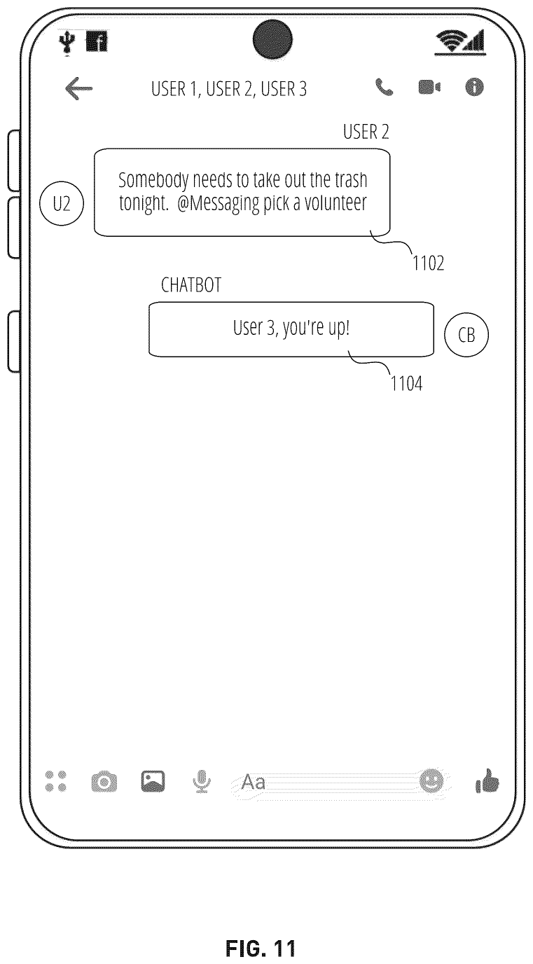

Another example of a group bot is depicted in FIG. 11. In this case, the bot is a picker bot that chooses between conversation participants and/or preferences.

In the depicted example, the invoking message 1102 expressly requests that the “Messaging” bot select one of the participants in the conversation. The bot may do so at random, or may use another selection method (e.g., round-robin). In this particular embodiment, the shareable information may simply be the list of participants in the group, although more complicated picker-bots are also possible. For example, a user may invoke the bot in order to choose an option for dinner, with the bot choosing from among the preferences of the conversation participants. In that case, the bot may retrieve the users' shareable preferences from a messaging profile, social network, or other accessible source of information.

The invoking message 1102 may serve as the user service prompt, as previously described. The bot's response may be provided in a bot message 1104, or in another element of the same interface in which the conversation messages are presented.

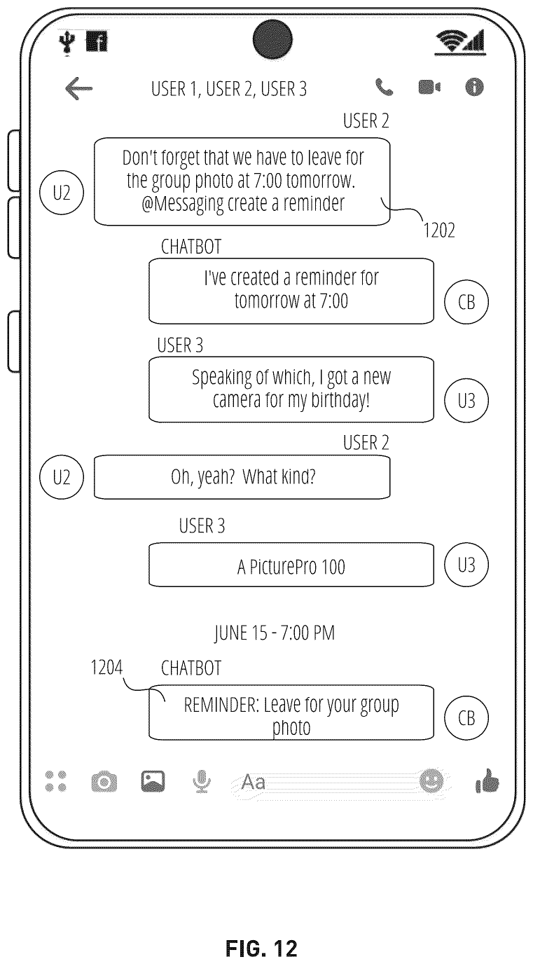

Another example of a group bot is depicted in FIG. 12; this embodiment provides a group reminder bot. The invoking message 1202 includes an explicit request for the bot to remind the group of something. The bot may apply natural language processing to determine the content and time for the reminder. The bot may be configured to awaken at the time of the reminder and send a message into the group conversation with the content of the reminder.

The bot may store the reminder as shareable information for the group members; for example, the bot may store a data structure at a data server with the conversation's thread identifier and the content of the message. The bot may request that the bot server awaken the bot at the time of the reminder so that the bot can retrieve the data structure and send the reminder as a message into the group conversation.

The invoking message 1202 may serve as the user service prompt, as previously described, and may be presented in the group conversation. The bot's response may be provided in a bot bot response message 1204, or in another element of the same interface in which the conversation messages are presented.

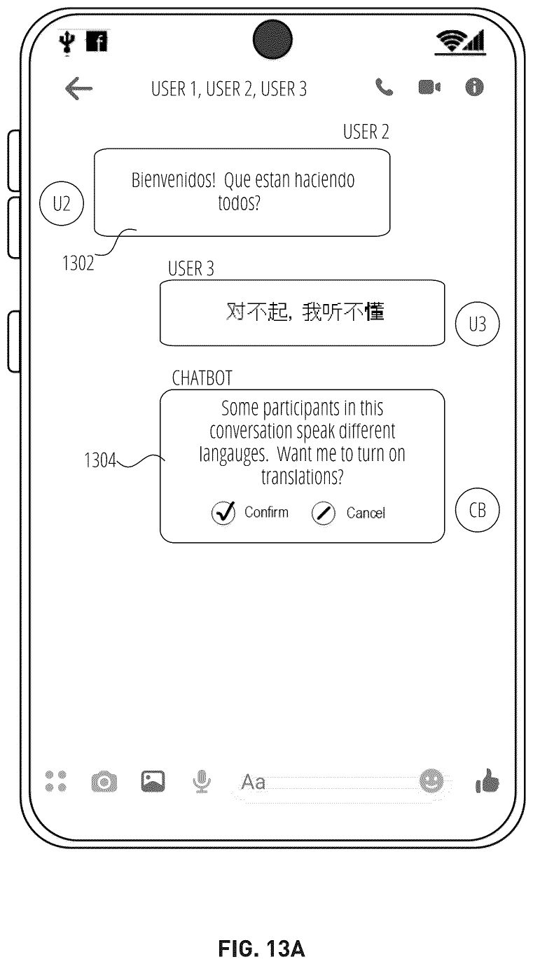

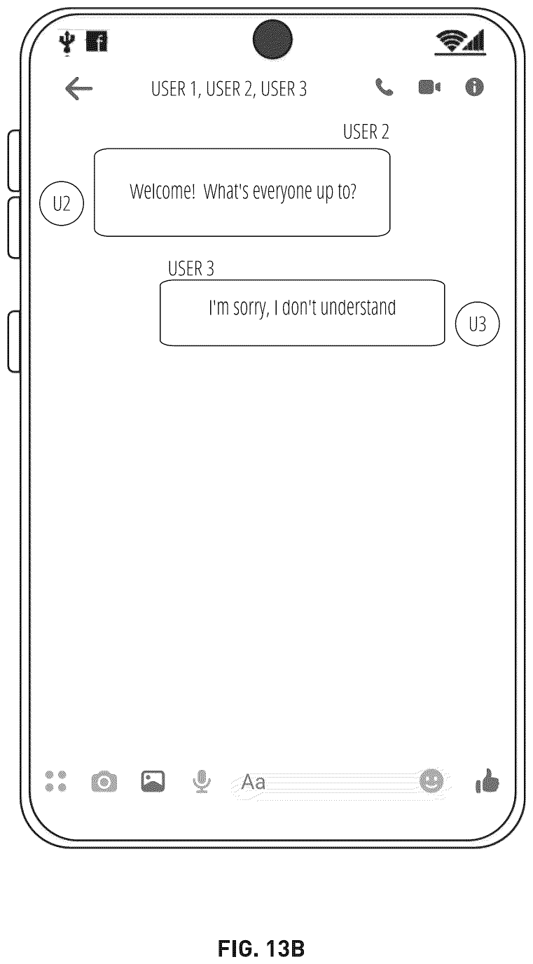

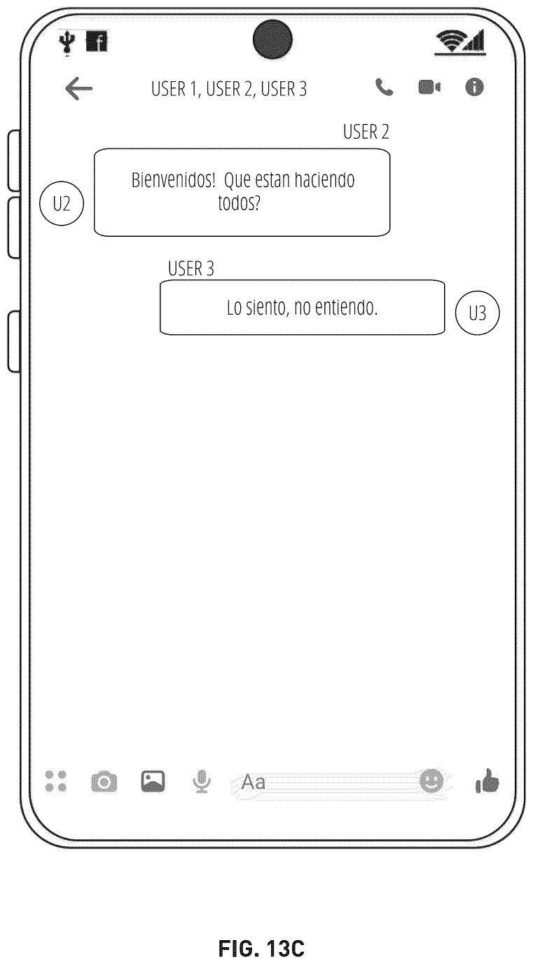

FIG. 13A, FIG. 13B, and FIG. 13C depict various examples of a group bot configured to provide translation services in the conversation.

In this example, the user service prompt may simply be a message 1302 sent into the conversation that is written in a language that does not match at least one user's core language (or this may be surmised without expressly analyzing the language of the message when a user with one core language transmits a message 1302 into a conversation with another user who does not share the core language of the first user). Alternatively or in addition, the bot may detect when a user expresses confusion (e.g., “sorry, I didn't understand that” or “I don't speak Farsi”), which may trigger the bot to provide (or suggest) translation capabilities.

In these cases, the shareable user information may include the core language(s) spoken by each user. The core languages spoken by the user may be indicated in a user profile with the messaging service, in a related social networking service, or may be ascertained based on an analysis of the languages present in messages sent and/or received by the user.

In the example depicted in FIG. 13A, the bot has detected a language mismatch and suggested translation capabilities in a bot suggestion message 1304. In alternative embodiments, the bot might be user-configured (e.g., by an administrator of the conversation) to simply begin translating messages.

The bot could provide translation services in several ways. In one embodiment, the bot might present different translations to different users, based on the users' own primary languages. The bot might replace any transmitted messages that are not in the user's core languages in the conversation's interface, which might include translating all of the messages into a different language spoken by the user. For instance, FIG. 13B depicts an example of the conversation of FIG. 13A as it might be presented by a translation bot in an interface of a user who's primary language is English (note that the first message, originally written in Spanish, has been translated, as has the second message, originally written in Mandarin). Alternatively, the bot might recognize that a user already speaks one of the languages in the conversation, and might translate any messages in a language not spoken by the user, as demonstrated in FIG. 13C (note that the first message, originally in Spanish, remains in the same language, but the second message has been translated into Spanish; this might be the interface as viewed by a native Spanish speaker).

Instead of replacing messages in the interface with translated messages, the bot might transmit its own translation for each message sent to the group. The bot might transmit the messages in the core language or languages spoken by members of the group. In some embodiments, the bot might present a mini-app in the form of a bar at the top or bottom of the screen; as messages are transmitted into the conversation, appropriate translations based on the participants' core languages may be presented in the mini-app. Moreover, a user may be permitted to select an existing message in the conversation in order to see the translation in the mini-app.

In some embodiments, the bot may be selectively invoked to translate only certain messages. A similar bot could be used to offer text-to-speech (or vice versa) capabilities for the visually impaired, or transcription services for the deaf for for audio clips sent into a conversation.

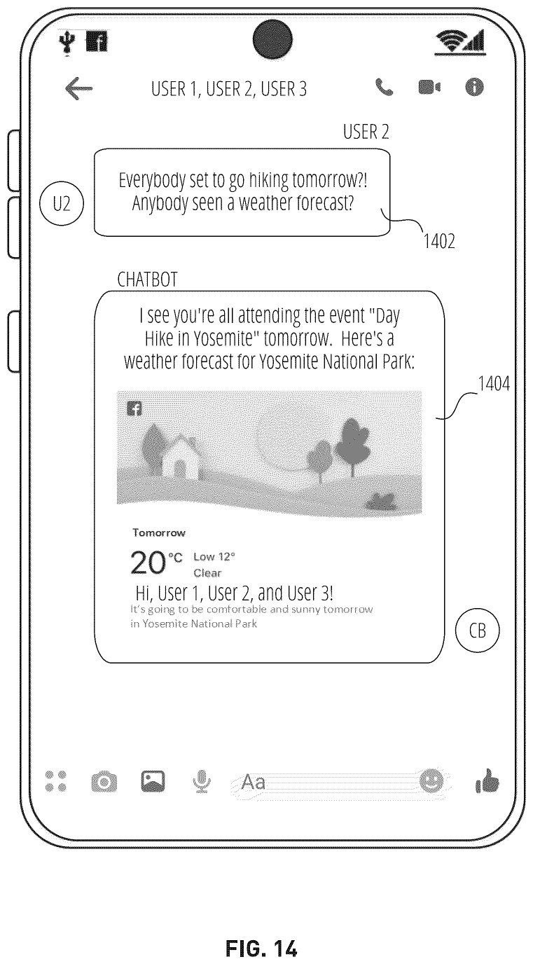

Yet another example of a group bot for providing weather forecasts is depicted in FIG. 14. In this example, an invoking message 1402 may serve as the user service prompt. The invoking message 1402 includes language evidencing an intent to request a weather forecast.

In response to the invoking message 1402, the bot may retrieve shareable information in the form of the locations of participants in the conversation. The locations may be home locations as indicated in the user's profile, a user's current location as indicated (e.g.) by the user checking in at a place via a social network or otherwise providing location data, and/or a location of the user in the future. The particular location to be used may be user-configurable, or may be determined by analyzing the conversation (e.g., the invoking message).

In this example, the invoking message 1402 indicates that the user is interested in the weather for an event the conversation participants are engaging in. The bot may therefore consult the shareable user information (e.g., shared calendars) to determine if such an event is accessible to the bot. Based on the date, time, and/or location of the event, the bot may retrieve a weather forecast from a bot weather service.

The conversation (including the invoking message 1402) may be analyzed to determine an extent of the forecast. For example, the user may be requesting a forecast for a particular time, for a day, for a week, etc.

The bot's response may be provided in a bot response message 1404, or in another element of the same interface in which the conversation messages are presented. The bot response message 1404 may include a link that can be followed to receive more details of the forecast.

Note that, in the examples previously described, both explicit and implied bot invocations have been used. It is understood that either type of invocation could be used with any type of bot, and so the depicted examples may not be the only way to invoke the bots described. Furthermore, these examples are not the only ways that group bots may be applied, and other applications will be apparent to one of ordinary skill in the art in view of the examples and explanations provided.

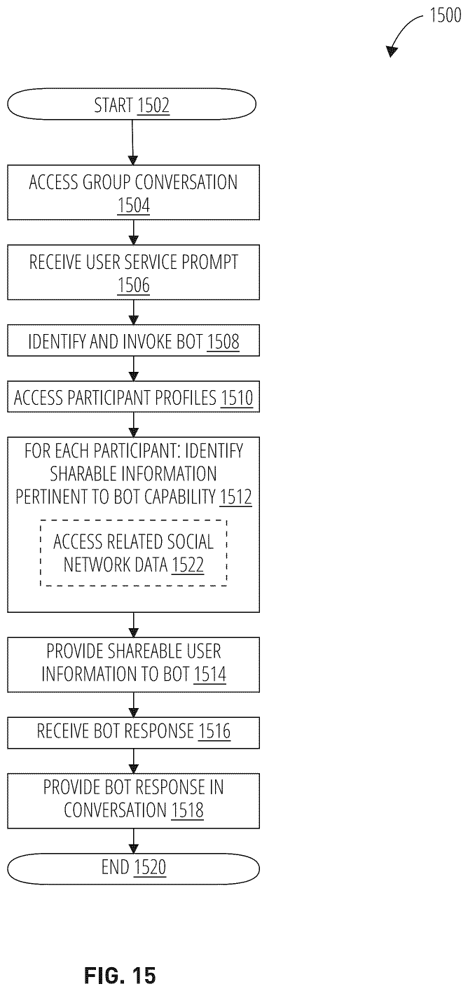

FIG. 15 depicts exemplary group bot logic 1500 providing bot capabilities shared between a group participating in a conversation, according to an exemplary embodiment. The group bot logic 1500 may be embodied as a computer-implemented method or as instructions stored on a non-transitory computer-readable storage medium, and may be configured to cause a processor to perform the logical blocks included in FIG. 15. In some embodiments, the group bot logic 1500 may be performed by a computing system configured to perform the logical blocks included in FIG. 15.

Processing begins at start block 1502. At block 1504, a group conversation may be accessed (e.g., by the messaging components previously described). The group conversation may be a message thread associated with a thread ID and involving multiple participants. The group conversation may be presented in a conversation interface of a messaging application on a client device, the interface displaying the messages of the conversation.

At block 1506, the messaging component may receive a user service prompt including natural language. The user service prompt may include an express invocation of a bot, or may include an implicit request to provide bot functionality. The bot may be a group bot whose capabilities are shared between members of the group (and not provided solely to one group member specifically). The user service prompt may be received directly in the conversation thread, such as by including the user service prompt in a message sent by one of the users. At block 1508, one or more bots capable of responding to the user service prompt may be identified and invoked, as discussed above.

At block 1510, the bot may access the profiles of the conversation participants. Participant profiles may be public, and may provide shareable user information directly. The profiles may also identify, for the bot, linked services or applications that may provide additional sources of shareable information.

At block 1512, the messaging component (or the bot) may identify, for each participant, shareable information that is pertinent to the bot's capabilities. The shareable information may be associated with metadata or tags that allow the shareable information to be categorized; alternatively or in addition, the bot may provide the shareable information to a classifier that determines a category of the sharable information. The bot may be configured to operate on particular categories of information (e.g., interests, location data, user identifiers, etc.), and may select those categories that are pertinent to the bot's capabilities for further analysis.

Block 1512 may optionally include, at block 1522, accessing the user's public or shared information accessible in a social network associated with the messaging service. In some embodiments, the messaging service and the social networking service may provide common log-in credentials or a common authentication process, and may allow for cross-sharing of data between the services.

At block 1514, the shareable information identified at block 1512 may be provided to the bot. The shareable information may be included in an invocation command that invokes the bot, or separately as additional information. The bot may generate a response according to its capabilities by taking into account the shareable information from each member of the group. This may involve determining an optimal or semi-optimal solution that is the most acceptable to all group members, selecting one of the group members or a preference in a fair and unbiased way, or otherwise accounting for the needs or desires of the entire group.

At block 1516, the messaging component may receive the bot's response and may, at block 1518, provide the bot's response in the conversation. The bot's response may be provided in the form of a message transmitted into the group conversation, via a mini-app presented in the conversation's user interface, or in another way. The bot response is provided in a manner that a user viewing the messages of the conversation does not need to navigate away from the conversation in order to utilize the bot's capabilities. Thus, the bot's group capabilities are provided in-thread.

Processing may then proceed to done block 1520 and end.

### Computer-Implemented Embodiments

The embodiments described above may be performed by a messaging architecture, an example of which is next described with reference to FIG. 16.

FIG. 16 illustrates an embodiment of a plurality of servers implementing various functions of a messaging service 1600 suitable for use with exemplary embodiments. It will be appreciated that different distributions of work and functions may be used in various embodiments of a messaging service 1600.

The messaging service 1600 may comprise a domain name front end 1602. The domain name front end 1602 may be assigned one or more domain names associated with the messaging service 1600 in a domain name system (DNS). The domain name front end 1602 may receive incoming connections and distribute the connections to servers providing various messaging services.

The messaging service 1600 may comprise one or more chat server(s) 1606. The chat server(s) 1606 may comprise front-end servers for receiving and transmitting user-to-user messaging updates such as chat messages. Incoming connections may be assigned to the chat server(s) 1606 by the domain name front end 1602 based on workload balancing.

The messaging service 1600 may comprise backend servers 1644. The backend servers 1644 may perform specialized tasks in the support of the chat operations of the front-end chat server(s) 1606. A plurality of different types of backend servers 1644 may be used. It will be appreciated that the assignment of types of tasks to different backend servers 1644 may vary in different embodiments. In some embodiments some of the back-end services provided by dedicated servers may be combined onto a single server or a set of servers each performing multiple tasks divided between different servers in the embodiment described herein. Similarly, in some embodiments tasks of some of dedicated backend servers 1644 described herein may be divided between different servers of different server groups.

The messaging service 1600 may comprise one or more offline storage servers 1608. The one or more offline storage servers 1608 may store messaging content for currently-offline messaging clients in hold for when the messaging clients reconnect.

The messaging service 1600 may comprise one or more session servers 1610. The one or more session servers 1610 may maintain a session state of connected messaging clients.

The messaging service 1600 may comprise one or more presence servers 1614. The one or more presence servers 1614 may maintain presence information for the messaging service 1600. Presence information may correspond to user-specific information indicating whether or not a given user has an online messaging client and is available for chatting, has an online messaging client but is currently away from it, does not have an online messaging client, and any other presence state.

The messaging service 1600 may comprise one or more push storage servers 1612. The one or more push storage servers 1612 may cache push requests and transmit the push requests to messaging clients. Push requests may be used to wake messaging clients, to notify messaging clients that a messaging update is available, and to otherwise perform server-side-driven interactions with messaging clients.

The messaging service 1600 may comprise one or more group servers 1616. The one or more group servers 1616 may maintain lists of groups, add users to groups, remove users from groups, and perform the reception, caching, and forwarding of group chat messages.

The messaging service 1600 may comprise one or more block list servers 1630. The one or more block list servers 1630 may maintain user-specific block lists, the user-specific incoming-block lists indicating for each user the one or more other users that are forbidden from transmitting messages to that user. Alternatively or additionally, the one or more block list servers 1630 may maintain user-specific outgoing-block lists indicating for each user the one or more other users that that user is forbidden from transmitting messages to. It will be appreciated that incoming-block lists and outgoing-block lists may be stored in combination in, for example, a database, with the incoming-block lists and outgoing-block lists representing different views of a same repository of block information.

The messaging service 1600 may comprise one or more last seen last-seen information servers 1618. The one or more last seen last-seen information servers 1618 may receive, store, and maintain information indicating the last seen location, status, messaging client, and other elements of a user's last seen connection to the messaging service 1600.

The messaging service 1600 may comprise one or more key servers 1620. The one or more key servers may host public keys for public/private key encrypted communication.

The messaging service 1600 may comprise one or more profile photo servers 1622. The one or more profile photo servers 1622 may store and make available for retrieval profile photos for the plurality of users of the messaging service 1600.

The messaging service 1600 may comprise one or more spam-logging servers 1632. The one or more spam-logging servers 1632 may log known and suspected spam (e.g., unwanted messages, particularly those of a promotional nature). The one or more spam-logging servers 1632 may be operative to analyze messages to determine whether they are spam and to perform punitive measures, in some embodiments, against suspected spammers (users that send spam messages).

The messaging service 1600 may comprise one or more statistics servers 1634. The one or more statistics servers may compile and store statistics information related to the operation of the messaging service 1600 and the behavior of the users of the messaging service 1600.

The messaging service 1600 may comprise one or more web servers 1636. The one or more web servers 1636 may engage in hypertext transport protocol (HTTP) and hypertext transport protocol secure (HTTPS) connections with web browsers.

The messaging service 1600 may comprise one or more chat activity monitoring servers 1638. The one or more chat activity monitoring servers 1638 may monitor the chats of users to determine unauthorized or discouraged behavior by the users of the messaging service 1600. The one or more chat activity monitoring servers 1638 may work in cooperation with the spam-logging servers 1632 and block list servers 1630, with the one or more chat activity monitoring servers 1638 identifying spam or other discouraged behavior and providing spam information to the spam-logging servers 1632 and blocking information, where appropriate to the block list servers 1630.

The messaging service 1600 may comprise one or more sync servers 1640. The one or more sync servers 1640 may sync the messaging service 1600 with contact information from a messaging client, such as an address book on a mobile phone, to determine contacts for a user in the messaging service 1600.

The messaging service 1600 may comprise one or more multimedia servers 1642. The one or more multimedia servers may store multimedia (e.g., images, video, audio) in transit between messaging clients, multimedia cached for offline endpoints, and may perform transcoding of multimedia.

The messaging service 1600 may comprise one or more payment servers 1624. The one or more payment servers 1624 may process payments from users. The one or more payment servers 1624 may connect to external third-party servers for the performance of payments.

The messaging service 1600 may comprise one or more registration servers 1626. The one or more registration servers 1626 may register new users of the messaging service 1600.

The messaging service 1600 may comprise one or more voice relay servers 1628. The one or more voice relay servers 1628 may relay voice-over-internet-protocol (VoIP) voice communication between messaging clients for the performance of VoIP calls.

In some embodiments, the messaging service 1600 may be an end-to-end encrypted (E2EE) messaging service, in which a sending device encrypts information for decryption by a receiving device. The intermediate servers of the messaging service 1600 may assist in the setup of an E2EE session, and may facilitate delivery of communications between the devices, but may be unable to decrypt (and therefore access) the content of the communications. In an E2EE environment, some adjustments may need to be made to procedures that would be performed by the server in a non-E2EE environment (eliminating these procedures, adjusting them, or moving them to one or more of the client devices).

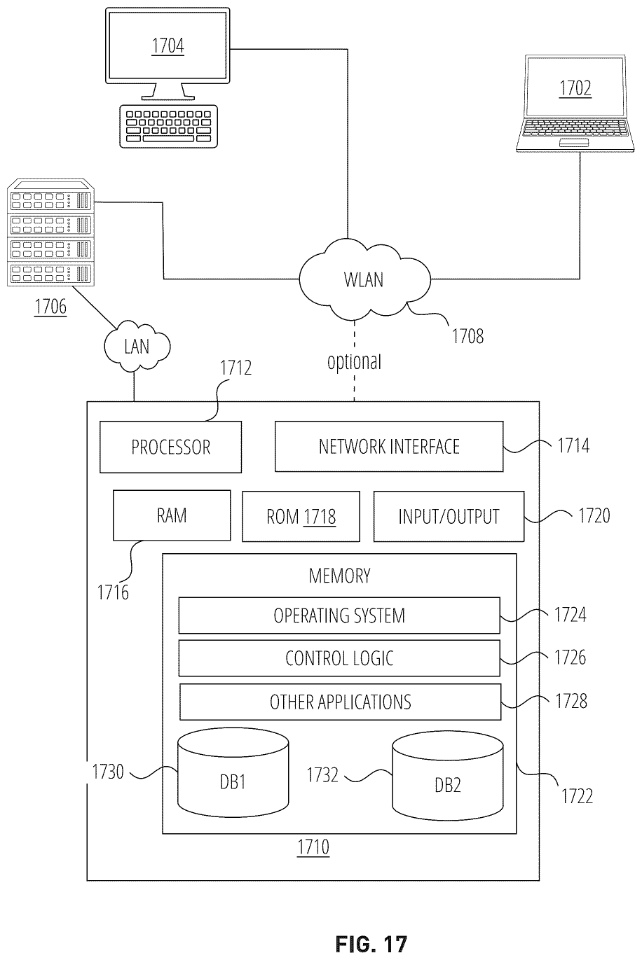

FIG. 17 illustrates one example of a system architecture and data processing device that may be used to implement one or more illustrative aspects described herein in a standalone and/or networked environment. Various network nodes, such as the data server 1710, web server 1706, computer 1704, and laptop 1702 may be interconnected via a wide area network 1708 (WAN), such as the internet. Other networks may also or alternatively be used, including private intranets, corporate networks, LANs, metropolitan area networks (MANs) wireless networks, personal networks (PANs), and the like. Network 1708 is for illustration purposes and may be replaced with fewer or additional computer networks. A local area network (LAN) may have one or more of any known LAN topology and may use one or more of a variety of different protocols, such as ethernet. Devices data server 1710, web server 1706, computer 1704, laptop 1702 and other devices (not shown) may be connected to one or more of the networks via twisted pair wires, coaxial cable, fiber optics, radio waves or other communication media.

Computer software, hardware, and networks may be utilized in a variety of different system environments, including standalone, networked, remote-access (aka, remote desktop), virtualized, and/or cloud-based environments, among others.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 1710, web server 1706, and client computer 1704, laptop 1702. Data server 1710 provides overall access, control and administration of databases and control software for performing one or more illustrative aspects described herein. Data serverdata server 1710 may be connected to web server 1706 through which users interact with and obtain data as requested. Alternatively, data server 1710 may act as a web server itself and be directly connected to the internet. Data server 1710 may be connected to web server 1706 through the network 1708 (e.g., the internet), via direct or indirect connection, or via some other network. Users may interact with the data server 1710 using remote computer 1704, laptop 1702, e.g., using a web browser to connect to the data server 1710 via one or more externally exposed web sites hosted by web server 1706. Client computer 1704, laptop 1702 may be used in concert with data server 1710 to access data stored therein, or may be used for other purposes. For example, from client computer 1704, a user may access web server 1706 using an internet browser, as is known in the art, or by executing a software application that communicates with web server 1706 and/or data server 1710 over a computer network (such as the internet).

Servers and applications may be combined on the same physical machines, and retain separate virtual or logical addresses, or may reside on separate physical machines. FIG. 17 illustrates just one example of a network architecture that may be used, and those of skill in the art will appreciate that the specific network architecture and data processing devices used may vary, and are secondary to the functionality that they provide, as further described herein. For example, services provided by web server 1706 and data server 1710 may be combined on a single server.

Each component data server 1710, web server 1706, computer 1704, laptop 1702 may be any type of known computer, server, or data processing device. Data server 1710, e.g., may include a processor 1712 controlling overall operation of the data server 1710. Data server 1710 may further include RAM 1716, ROM 1718, network interface 1714, input/output interfaces 1720 (e.g., keyboard, mouse, display, printer, etc.), and memory 1722. Input/output interfaces 1720 may include a variety of interface units and drives for reading, writing, displaying, and/or printing data or files. Memory 1722 may further store operating system software 1724 for controlling overall operation of the data server 1710, control logic 1726 for instructing data server 1710 to perform aspects described herein, and other application software 1728 providing secondary, support, and/or other functionality which may or may not be used in conjunction with aspects described herein. The control logic may also be referred to herein as the data server software control logic 1726. Functionality of the data server software may refer to operations or decisions made automatically based on rules coded into the control logic, made manually by a user providing input into the system, and/or a combination of automatic processing based on user input (e.g., queries, data updates, etc.).

Memory 1122 may also store data used in performance of one or more aspects described herein, including a first database 1732 and a second database 1730. In some embodiments, the first database may include the second database (e.g., as a separate table, report, etc.). That is, the information can be stored in a single database, or separated into different logical, virtual, or physical databases, depending on system design. Web server 1706, computer 1704, laptop 1702 may have similar or different architecture as described with respect to data server 1710. Those of skill in the art will appreciate that the functionality of data server 1710 (or web server 1706, computer 1704, laptop 1702) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

### CONCLUSION

The components and features of the devices described above may be implemented using any combination of discrete circuitry, application specific integrated circuits (ASICs), logic gates and/or single chip architectures. Further, the features of the devices may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It will be appreciated that the exemplary devices shown in the block diagrams described above may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

At least one computer-readable storage medium may include instructions that, when executed, cause a system to perform any of the computer-implemented methods described herein.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately may be employed in combination with each other unless it is noted that the features are incompatible with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. A computer-implemented method, comprising:
receiving, based on a group messaging interaction between a plurality of participants of a group messaging thread in a messaging application, a user service prompt comprising natural language, wherein the user service prompt represents a user intent having a confidence score exceeding a predefined threshold;
comparing the user intent represented by the user service prompt to a bot capability table that represents a plurality of bot capability catalogs as a plurality of numerical bot capability vectors, wherein the plurality of bot capability catalogs respectively express capabilities of a plurality of bots in natural language form, and wherein comparing the user intent to the bot capability table comprises:
performing a similarity search of the plurality of numerical bot capability vectors based on a numerical user intent vector representing the user intent; and
selecting one of the plurality of bots whose numerical bot capability vector similarity to the numerical user intent vector is higher than a predefined similarity threshold;
identifying sharable user information for each of the plurality of participants of the group messaging thread that is pertinent to the group messaging interaction;
invoking the selected bot and providing the sharable user information to the bot;
receiving, from the bot, a response to the user service prompt determined, at least in part, based on the sharable user information; and
providing the response of the bot as a message in the group messaging thread.

2. The computer-implemented method of claim 1, wherein the sharable user information comprises a user preference for each of the plurality of participants in the group messaging thread, and the bot is configured to identify a calendar event that the bot predicts the plurality of participants will be interested in attending.

3. The computer-implemented method of claim 1, wherein the sharable user information comprises at least one of identities or preferences of the plurality of participants in the group messaging thread, and the bot is configured to provide a selection of a subset of the identities or preferences.

4. The computer-implemented method of claim 1, wherein the sharable user information comprises a reminder pertaining to the plurality of participants in the group messaging thread.

5. The computer-implemented method of claim 1, wherein the sharable user information comprises respective core languages spoken by the plurality of participants in the group messaging thread, and the bot is configured to provide a translation of a message in the group messaging thread based on a difference in the respective core languages.

6. The computer-implemented method of claim 1, wherein the sharable user information comprises respective locations of the plurality of participants in the group messaging thread, and the bot is configured to provide an indication of weather at the respective locations.

7. The computer-implemented method of claim 1, wherein the plurality of participants in the group messaging thread are each users of a social network, and the sharable user information is retrieved from the social network.

8. A non-transitory computer-readable storage medium, the computer-readable storage medium including instructions that when executed by a computer, cause the computer to:
receive, based on a group messaging interaction between a plurality of participants of a group messaging thread in a messaging application, a user service prompt comprising natural language, wherein the user service prompt represents a user intent having a confidence score exceeding a predefined threshold;
compare the user intent represented by the user service prompt to a bot capability table that represents a plurality of bot capability catalogs as a plurality of numerical bot capability vectors, wherein the plurality of bot capability catalogs respectively express capabilities of a plurality of bots in natural language form, and wherein comparing the user intent to the bot capability table comprises:
perform a similarity search of the plurality of numerical bot capability vectors based on a numerical user intent vector representing the user intent and
select one of the plurality of bots whose numerical bot capability vector similarity to the numerical user intent vector is higher than a predefined similarity threshold;
identify sharable user information for each of the plurality of participants of the group messaging thread that is pertinent to the group messaging interaction;
invoke the selected bot and providing the sharable user information to the bot;
receive, from the bot, a response to the user service prompt determined, at least in part, based on the sharable user information; and
provide the response of the bot as a message in the group messaging thread.

9. The non-transitory computer-readable storage medium of claim 8, wherein the sharable user information comprises a user preference for each of the plurality of participants in the group messaging thread, and the bot is configured to identify a calendar event that the bot predicts the plurality of participants will be interested in attending.

10. The non-transitory computer-readable storage medium of claim 8, wherein the sharable user information comprises at least one of identities or preferences of the plurality of participants in the group messaging thread, and the bot is configured to provide a selection of a subset of the identities or preferences.

11. The non-transitory computer-readable storage medium of claim 8, wherein the sharable user information comprises a reminder pertaining to the plurality of participants in the group messaging thread.

12. The non-transitory computer-readable storage medium of claim 8, wherein the sharable user information comprises respective core languages spoken by the plurality of participants in the group messaging thread, and the bot is configured to provide a translation of a message in the group messaging thread based on a difference in the respective core languages.

13. The non-transitory computer-readable storage medium of claim 8, wherein the sharable user information comprises respective locations of the plurality of participants in the group messaging thread, and the bot is configured to provide an indication of weather at the respective locations.

14. The non-transitory computer-readable storage medium of claim 8, wherein the plurality of participants in the group messaging thread are each users of a social network, and the sharable user information is retrieved from the social network.

15. A computing apparatus comprising:
a processor; and
a memory storing instructions that, when executed by the processor, configure the apparatus to,
receive, based on a group messaging interaction between a plurality of participants of a group messaging thread in a messaging application, a user service prompt comprising natural language, wherein the user service prompt represents a user intent having a confidence score exceeding a predefined threshold;
compare the user intent represented by the user service prompt to a bot capability table that represents a plurality of bot capability catalogs as a plurality of numerical bot capability vectors, wherein the plurality of bot capability catalogs respectively express capabilities of a plurality of bots in natural language form, and wherein comparing the user intent to the bot capability table comprises:
perform a similarity search of the plurality of numerical bot capability vectors based on a numerical user intent vector representing the user intent; and
select one of the plurality of bots whose numerical bot capability vector similarity to the numerical user intent vector is higher than a predefined similarity threshold;
identify sharable user information for each of the plurality of participants of the group messaging thread that is pertinent to the group messaging interaction;
invoke the selected bot and providing the sharable user information to the bot;
receive, from the bot, a response to the user service prompt determined, at least in part, based on the sharable user information; and
provide the response of the bot as a message in the group messaging thread.

16. The computing apparatus of claim 15, wherein the sharable user information comprises a user preference for each of the plurality of participants in the group messaging thread, and the bot is configured to identify a calendar event that the bot predicts the plurality of participants will be interested in attending.

17. The computing apparatus of claim 15, wherein the sharable user information comprises at least one of identities or preferences of the plurality of participants in the group messaging thread, and the bot is configured to provide a selection of a subset of the identities or preferences.

18. The computing apparatus of claim 15, wherein the sharable user information comprises a reminder pertaining to the plurality of participants in the group messaging thread.

19. The computing apparatus of claim 15, wherein the sharable user information comprises respective core languages spoken by the plurality of participants in the group messaging thread, and the bot is configured to provide a translation of a message in the group messaging thread based on a difference in the respective core languages.

20. The computing apparatus of claim 15, wherein the plurality of participants in the group messaging thread are each users of a social network, and the sharable user information is retrieved from the social network.
